(19) United States
(12) Patent Application Publication
(10) Pub. No.: US 2020/0255325 A1
(43) Pub. Date: Aug. 13, 2020

(54) POLYCHROMATIC GLASS & GLASS-CERAMIC ARTICLES AND METHODS OF MAKING THE SAME

(71) Applicant: CORNING INCORPORATED, CORNING, NY (US)

(72) Inventors: Matthew John Dejneka, Corning, NY (US); Jesse Kohl, Horseheads, NY (US)

(21) Appl. No.: 16/777,329

(22) Filed: Jan. 30, 2020

Related U.S. Application Data
(60) Provisional application No. 62/804,271, filed on Feb. 12, 2019.

(51) Int. Cl. C03C 3/118; C03C 3/091; C03C 4/06

(52) U.S. Cl. CPC C03C 3/118; C03C 2204/00; C03C 4/065; C03C 3/091

(57) ABSTRACT

An article that includes: SiO₂ from 40 mol % to 80 mol %; Al₂O₃ from 1 mol % to 15 mol %; B₂O₃ from 5 mol % to 50 mol %; WO₃ from 1 mol % to 15 mol %; WO₃ plus MoO₃ from 1 mol % to 18 mol %; SnO₂ from 0.01 mol % to 1 mol %; and R₂O from 1.1 mol % to 16 mol %. The R₂O is one or more of Li₂O, Na₂O, K₂O, Rb₂O and Cs₂O. R₂O minus Al₂O₃ ranges from +0.1 mol % to +4 mol %.

This application claims the benefit of priority to U.S. Provisional Application Ser. No. 62/804,271 filed on Feb. 12, 2019, the content of which is relied upon and incorporated herein by reference in its entirety.

### FIELD OF THE DISCLOSURE

The present disclosure generally relates to polychromatic glass and glass-ceramic articles, and more specifically, to compositions and methods of forming polychromatic tungsten and molybdenum bronze glass and glass-ceramic articles.

### BACKGROUND

Colored and/or reflective glass articles are used in a variety of applications. Low production volumes, coupled with the down time and un-sellable glass that is produced when a glass tank is transitioned from one color to another, makes offering a range of colors of the articles economically challenging. For example, with an increasing number of colors offered, either separate production lines and/or more un-sellable glass must be produced.

The development of polychromatic glass materials is challenging as there are a select group of noble and transition metal-containing glasses that have modulatable optical transmittance; all either fail to achieve required transmittance or to produce a sufficiently broad range of colors from a single composition for sunglasses, filters, or colored glasses. In addition, these conventional compositions contain volatile halides which makes them difficult to reproduce. Most conventional silver- and copper-containing glasses can be thermally darkened, but do not produce a wide range of colors. Gold can produce a range of colors including reds to purples, to blues, but only over a limited range of optical densities for a single composition. Coloration typically achieved with conventional gold-, silver- and copper-containing glasses is a combination of a surface plasmon resonance and scattering due to the large particle size (on the order of 100 nm). This scattering is undesirable for optical lens material. Other conventional methods of producing colored or reflective articles (e.g., through the application of metallic films and/or coatings) exhibit poor abrasion resistance, excessive reflection, iridescence, variability in color as a function of viewing angle, and poor ion exchangeability.

More recently, some polychromatic glass-ceramics have been developed with transmittance and polychromatic properties sufficient for use in sunglasses, filters and colored glasses. These glass-ceramics, however, are costly from a raw material and processing standpoint as they have significant silver oxide and tungsten oxide levels.

As such, the development of a single, relatively low cost material composition that can be processed after fabrication (e.g., by thermal treatment) to produce a range of colors while permitting a desired level of transmittance may be advantageous. Not only would a “single composition” approach yield performance benefits, it would also significantly lower the cost of colored and/or reflective article production.

### SUMMARY OF THE DISCLOSURE

According to a feature of the present disclosure, an article includes: SiO₂ from 40 mol % to 80 mol %; Al₂O₃ from 1 mol % to 15 mol %; B₂O₃ from 5 mol % to 50 mol %; WO₃ from 1 mol % to 15 mol %; WO₃ plus MoO₃ from 1 mol % to 18 mol %; SnO₂ from 0.01 mol % to 1 mol %; and R₂O from 1.1 mol % to 16 mol %. The R₂O is one or more of Li₂O, Na₂O, K₂O, Rb₂O and Cs₂O. R₂O minus Al₂O₃ ranges from +0.1 mol % to +4 mol %.

According to a feature of the present disclosure, an article includes: SiO₂ from 45 mol % to 75 mol %; Al₂O₃ from 7 mol % to 15 mol %; B₂O₃ from 5 mol % to 25 mol %; WO₃ from 1 mol % to 7 mol %; WO₃ plus MoO₃ from 2 mol % to 10 mol %; SnO₂ from 0.05 mol % to 0.4 mol %; and R₂O from 8 mol % to 16 mol %. The R₂O is one or more of Li₂O, Na₂O, K₂O, Rb₂O and Cs₂O. R₂O minus Al₂O₃ ranges from +1 mol % to +3 mol %.

According to a feature of the present disclosure, an article includes: SiO₂ from 50 mol % to 56 mol %; Al₂O₃ from 10 mol % to 12 mol %; B₂O₃ from 10 mol % to 15 mol %; WO₃ from 2 mol % to 4 mol %; WO₃ plus MoO₃ from 3 mol % to 6 mol %; SnO₂ from 0.1 mol % to 0.3 mol %; and R₂O from 11.1 mol % to 16.1 mol %. The R₂O is one or more of Li₂O, Na₂O, K₂O, Rb₂O and Cs₂O. R₂O minus Al₂O₃ ranges from +1.1 mol % to +2 mol %.

According to a feature of the present disclosure, an article includes: SiO₂ from 40 mol % to 80 mol %; Al₂O₃ from 1 mol % to 15 mol %; B₂O₃ from 5 mol % to 50 mol %; WO₃ from 1 mol % to 15 mol %; WO₃ plus MoO₃ from 1 mol % to 18 mol %; SnO₂ from 0.01 mol % to 1 mol %; R₂O from 1.1 mol % to 16 mol %; and a plurality of precipitates comprising an oxide of one or more of the chemical form MₓWO₃ and MₓMoO₃, wherein M is one or more of Li, Na, K, Rb and Cs and 0<x<1. The R₂O is one or more of Li₂O, Na₂O, K₂O, Rb₂O and Cs₂O. R₂O minus Al₂O₃ ranges from +0.1 mol % to +4 mol %.

According to a first aspect, an article is provided that includes: SiO₂ from 40 mol % to 80 mol %; Al₂O₃ from 1 mol % to 15 mol %; B₂O₃ from 5 mol % to 50 mol %; WO₃ from 1 mol % to 15 mol %; WO₃ plus MoO₃ from 1 mol % to 18 mol %; SnO₂ from 0.01 mol % to 1 mol %; and R₂O from 1.1 mol % to 16 mol %. Further, the R₂O is one or more of Li₂O, Na₂O, K₂O, Rb₂O and Cs₂O, wherein R₂O—Al₂O₃ ranges from +0.1 mol % to +4 mol %.

According to a second aspect, the article of aspect 1 is provided, further including: P₂O₅ from 0 mol % to 3 mol %; and F from 0 mol % to 15 mol %.

According to a third aspect, the article of aspect 1 or 2 is provided, further including: RO from 0 mol % to 2 mol %, wherein RO is one or more of MgO, CaO, SrO and BaO.

According to a fourth aspect, the article of any one of aspects 1-3 is provided, wherein the article is substantially free of Au, Ag, V and Cu.

According to a fifth aspect, the article of any one of aspects 1-4 is provided, wherein the article comprises a transmittance of at least 7% within a wavelength band from 390 nm to 700 nm at a thickness of 1.9 mm.

According to a sixth aspect, the article of any one of aspects 1-5 is provided, wherein the article exhibits an average absorbance from 0.2 OD/mm to 1.5 OD/mm in a wavelength band from 700 nm to 2000 nm.

According to a seventh aspect, the article of any one of aspects 1-6 is provided, wherein the article exhibits a minimum absorbance from 0.1 OD/mm to 1.2 OD/mm in a wavelength band from 365 nm to 2000 nm.

According to an eighth aspect, the article of any one of aspects 1-7 is provided, wherein the article exhibits a set of transmitted color coordinates having: a minimum X value from 0.25 to 0.45 and a minimum Y value from 0.3 to 0.5, as measured under a CIE Standard illuminant D65 at 2°.

According to a ninth aspect, an article is provided that includes: SiO₂ from 45 mol % to 75 mol %; Al₂O₃ from 7 mol % to 15 mol %; B₂O₃ from 5 mol % to 25 mol %; WO₃ from 1 mol % to 7 mol %; WO₃ plus MoO₃ from 2 mol % to 10 mol %; SnO₂ from 0.05 mol % to 0.4 mol %; and R₂O from 8 mol % to 16 mol %, wherein the R₂O is one or more of Li₂O, Na₂O, K₂O, Rb₂O and Cs₂O. Further, R₂O—Al₂O₃ ranges from +1 mol % to +3 mol %.

According to a tenth aspect, the article of aspect 9 is provided, further including: P₂O₅ from 0 mol % to 2 mol %; and F from 1 mol % to 10 mol %.

According to an eleventh aspect, the article aspect 9 or aspect 10 is provided, further including: RO from 0.01 mol % to 1 mol %, wherein RO is one or more of MgO, CaO, SrO and BaO.

According to a twelfth aspect, the article of any one of aspects 9-11 is provided, wherein the article is substantially free of Au, Ag, V and Cu.

According to a thirteenth aspect, the article of any one of aspects 9-12 is provided, wherein the article comprises a transmittance of at least 7% within a wavelength band from 390 nm to 700 nm at a thickness of 1.9 mm.

According to a fourteenth aspect, the article of any one of aspects 9-13 is provided, wherein the article exhibits an average absorbance from 0.25 OD/mm to 1.30 OD/mm in a wavelength band from 700 nm to 2000 nm.

According to a fifteenth aspect, the article of any one of aspects 9-14 is provided, wherein the article exhibits a minimum absorbance from 0.15 OD/mm to 1.1 OD/mm in a wavelength band from 365 nm to 2000 nm.

According to a sixteenth aspect, the article of any one of aspects 9-15 is provided, wherein the article exhibits a set of transmitted color coordinates having: a minimum X value from 0.3 to 0.4 and a minimum Y value from 0.35 to 0.41, as measured under a CIE Standard illuminant D65 at 2°.

According to a seventeenth aspect, an article is provided that includes: SiO₂ from 50 mol % to 56 mol %; Al₂O₃ from 10 mol % to 12 mol %; B₂O₃ from 10 mol % to 15 mol %; WO₃ from 2 mol % to 4 mol %; WO₃ plus MoO₃ from 3 mol % to 6 mol %; SnO₂ from 0.1 mol % to 0.3 mol %; and R₂O from 11.1 mol % to 16.1 mol %, wherein the R₂O is one or more of Li₂O, Na₂O, K₂O, Rb₂O and Cs₂O. Further, R₂O—Al₂O₃ ranges from +1.1 mol % to +2 mol %.

According to an eighteenth aspect, the article of aspect 17 is provided, further including: P₂O₅ from 0 mol % to 1.5 mol %; and F from 3 mol % to 7 mol %.

According to a nineteenth aspect, the article of aspect 17 or aspect 18 is provided, further including: RO from 0.05 mol % to 0.5 mol %, wherein RO is one or more of MgO, CaO, SrO and BaO.

According to a twentieth aspect, the article of any one of aspects 17-19 is provided, wherein the article is substantially free of Au, Ag, V and Cu.

According to a twenty-first aspect, an article is provided that includes: SiO₂ from 40 mol % to 80 mol %; Al₂O₃ from 1 mol % to 15 mol %; B₂O₃ from 5 mol % to 50 mol %; WO₃ from 1 mol % to 15 mol %; WO₃ plus MoO₃ from 1 mol % to 18 mol %; SnO₂ from 0.01 mol % to 1 mol %; R₂O from 1.1 mol % to 16 mol %; and a plurality of precipitates comprising an oxide of one or more of the chemical forms MₓWO₃ and MₓMoO₃, wherein M is one or more of Li, Na, K, Rb and Cs and 0<x<1. Further, the R₂O is one or more of Li₂O, Na₂O, K₂O, Rb₂O and Cs₂O. In addition, R₂O—Al₂O₃ ranges from +0.1 mol % to +4 mol %.

According to a twenty-second aspect, the article of aspect 21 is provided, further including: P₂O₅ from 0 mol % to 3 mol %; and F from 0 mol % to 15 mol %.

According to a twenty-third aspect, the article of aspect 21 or 22 is provided, further including: RO from 0 mol % to 2 mol %, wherein RO is one or more of MgO, CaO, SrO and BaO.

According to a twenty-fourth aspect, the article of any one of aspects 21-23 is provided, wherein the article is substantially free of Au, Ag, V and Cu.

According to a twenty-fifth aspect, the article of any one of aspects 21-24 is provided, wherein the plurality of precipitates comprises W⁵⁺.

According to a twenty-sixth aspect, the article of any one of aspects 21-25 is provided, wherein R₂O—Al₂O₃ ranges from +0.25 mol % to +2 mol %, and SnO₂ ranges from 0.05 mol % to 0.4 mol %.

These and other features, advantages, and objects of the present disclosure will be further understood and appreciated by those skilled in the art by reference to the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a cross-sectional view of an article, according to at least one example of the disclosure;

FIGS. 2A and 2B are plots of transmittance and absorbance, respectively, at 1.9 mm thickness over a wavelength range for different heat-treated examples of the Example 1 composition, according to various features of the present disclosure;

FIG. 3 is a plot of x and y color coordinates for heat-treated examples of Example 1 in view of the ANSI Z80.3-2001 traffic signal requirement, according to various features of the present disclosure;

FIG. 4 is a plot of transmittance at 0.7 mm thickness over a wavelength range for different heat-treated examples of the Example 2 composition, according to various features of the present disclosure; and

FIG. 5 is a plot of electro-paramagnetic resonance (EPR) measurements as a function of magnetic field for heat-treated examples of the Examples 3A-3C compositions and a heat-treated comparative composition, along with images of these examples, according to various features of the present disclosure.

### DETAILED DESCRIPTION

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

Unless otherwise specified, all compositions are expressed in terms of as-batched mole percent (mol %). As will be understood by those having ordinary skill in the art, various melt constituents (e.g., fluorine, alkali metals, boron, etc.) may be subject to different levels of volatilization (e.g., as a function of vapor pressure, melt time and/or melt temperature) during melting of the constituents. As such, the as-batched mole percent values used in relation to such constituents are intended to encompass values within ±0.2 mol % of these constituents in final, as-melted articles. With the foregoing in mind, substantial compositional equivalence between final articles and as-batched compositions is expected.

For purposes of this disclosure, the terms “bulk,” “bulk composition” and/or “overall compositions” are intended to include the overall composition of the entire article, which may be differentiated from a “local composition” or “localized composition” which may differ from the bulk composition owing to the formation of crystalline and/or ceramic phases.

As also used herein, the terms “article,” “glass-article,” “ceramic-article,” “glass-ceramics,” “glass elements,” “glass-ceramic article” and “glass-ceramic articles” may be used interchangeably, and in their broadest sense, to include any object made wholly or partly of glass and/or glass-ceramic material.

As used herein, a “glass state” refers to an inorganic amorphous phase material within the articles of the disclosure that is a product of melting that has cooled to a rigid condition without crystallizing. As used herein, a “glass-ceramic state” refers to an inorganic material within the articles of the disclosure which includes both the glass state and a “crystalline phase” and/or “crystalline precipitates” as described herein.

As used herein, “transmission”, “transmittance”, “optical transmittance” and “total transmittance” are used interchangeably in the disclosure and refer to external transmission or transmittance, which takes absorption, scattering and reflection into consideration. Fresnel reflection is not subtracted out of the transmission and transmittance values reported herein. In addition, any total transmittance values referenced over a particular wavelength range are given as an average of the total transmittance values measured over the specified wavelength range. Further, as also used herein, “average absorbance” is given as (2−log(average transmittance,%))/path length).

As used herein, “optical density units”, “OD” and “OD units” are used interchangeably in the disclosure to refer to optical density units, as commonly understood as a measure of absorbance of the material tested, as measured with a spectrometer given by OD=−log (I/I₀) where I₀ is the intensity of light incident on the sample and I is the intensity of light that is transmitted through the sample. Further, the terms “OD/mm” or “OD/cm” used in this disclosure are normalized measures of absorbance, as determined by dividing the optical density units (i.e., as measured by an optical spectrometer) by the thickness of the sample (e.g., in units of millimeters or centimeters). In addition, any optical density units referenced over a particular wavelength range (e.g., 3.3 OD/mm to 24.0 OD/mm in UV wavelengths from 280 nm to 380 nm) are given as an average value of the optical density units over the specified wavelength range.

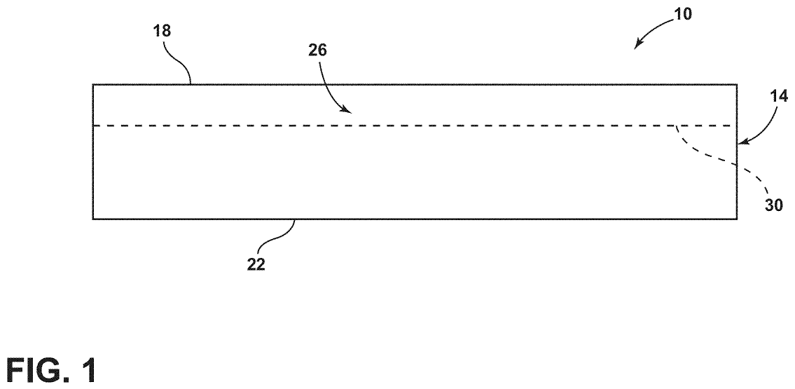

Referring now to FIG. 1, an article 10 is depicted that includes a substrate 14 having a glass and/or glass-ceramic composition according to the disclosure. The article 10 can be employed in any number of applications. For example, the article 10 and/or substrate 14 can be employed in the form of substrates, elements, covers and other elements in any number of optics related and/or aesthetic applications.

The substrate 14 defines or includes a pair of opposing primary surfaces 18, 22. In some examples of the article 10, the substrate 14 includes a compressive stress region 26. As shown in FIG. 1, the compressive stress region 26 extends from the primary surface 18 to a first selected depth 30 in the substrate. In some examples, the substrate 14 includes a comparable compressive stress region 26 that extends from the primary surface 18 to a second selected depth. Further, in some examples, multiple compressive stress regions 26 may extend from the primary surfaces 18, 22 and/or edges of the substrate 14. The substrate 14 may have a selected length and width, or diameter, to define its surface area. The substrate 14 may have at least one edge between the primary surfaces 18, 22 of the substrate 14 defined by its length and width, or diameter. The substrate 14 may also have a selected thickness.

As used herein, a “selected depth,” (e.g., selected depth 30) “depth of compression” and “DOC” are used interchangeably to define the depth at which the stress in the substrate 14, as described herein, changes from compressive to tensile. DOC may be measured by a surface stress meter, such as an FSM-6000, or a scattered light polariscope (SCALP) depending on the ion exchange treatment. Where the stress in a substrate 14 having a glass or a glass-ceramic composition is generated by exchanging potassium ions into the glass substrate, a surface stress meter is used to measure DOC. Where the stress is generated by exchanging sodium ions into the glass article, SCALP is used to measure DOC. Where the stress in the substrate 14 having a glass or glass-ceramic composition is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass substrates is measured by a surface stress meter. As also used herein, the “maximum compressive stress” is defined as the maximum compressive stress within the compressive stress region 26 in the substrate 14. In some examples, the maximum compressive stress is obtained at or in close proximity to the one or more primary surfaces 18, 22 defining the compressive stress region 26. In other examples, the maximum compressive stress is obtained between the one or more primary surfaces 18, 22 and the selected depth 30 of the compressive stress region 26.

In some examples of the article 10, as depicted in exemplary form in FIG. 1, the substrate 14 is selected from a chemically strengthened alumino-boro-silicate glass or glass-ceramic. For example, the substrate 14 can be selected from chemically strengthened alumino-boro-silicate glass or glass-ceramic having a compressive stress region 26 extending to a first selected depth 30 of greater than 10 μm, with a maximum compressive stress of greater than 150 MPa. In further examples, the substrate 14 is selected from a chemically strengthened alumino-boro-silicate glass or glass-ceramic having a compressive stress region 26 extending to a first selected depth 30 of greater than 25 μm, with a maximum compressive stress of greater than 400 MPa. The substrate 14 of the article 10 may also include one or more compressive stress regions 26 that extend from one or more of the primary surfaces 18, 22 to a selected depth 30 (or depths) having a maximum compressive stress of greater than 150 MPa, greater than 200 MPa, greater than 250 MPa, greater than 300 MPa, greater than 350 MPa, greater than 400 MPa, greater than 450 MPa, greater than 500 MPa, greater than 550 MPa, greater than 600 MPa, greater than 650 MPa, greater than 700 MPa, greater than 750 MPa, greater than 800 MPa, greater than 850 MPa, greater than 900 MPa, greater than 950 MPa, greater than 1000 MPa, and all maximum compressive stress levels between these values. In some examples, the maximum compressive stress is 2000 MPa or lower. In addition, the depth of compression (DOC) or first selected depth 30 can be set at 10 μm or greater, 15 μm or greater, 20 μm or greater, 25 μm or greater, 30 μm or greater, 35 μm or greater, and to even higher depths, depending on the thickness of the substrate 14 and the processing conditions associated with generating the compressive stress region 26. In some examples, the DOC is less than or equal to 0.3 times the thickness (t) of the substrate 14, for example 0.3 t, 0.28 t, 0.26 t, 0.25 t, 0.24 t, 0.23 t, 0.22 t, 0.21 t, 0.20 t, 0.19 t, 0.18 t, 0.15 t, or 0.10 t, and all values therebetween.

As will be explained in greater detail below, the article 10 is formed from an as-batched composition and is cast in a glass state. The article 10 may later be annealed and/or thermally processed (e.g., heat treated) to form a glass-ceramic state having a plurality of ceramic or crystalline particles. It will be understood that depending on the casting technique employed, the article 10 may readily crystallize and become a glass-ceramic without additional heat treatment (e.g., essentially be cast into the glass-ceramic state). In examples where a post-forming thermal processing is employed, a portion, a majority, substantially all or all of the article 10 may be converted from the glass state to the glass-ceramic state. As such, although compositions of the article 10 may be described in connection with the glass state and/or the glass-ceramic state, the bulk composition of the article 10 may remain substantially unaltered when converted between the glass and glass-ceramic states, despite localized portions of the article 10 having a different composition (i.e., owing to the formation of the ceramic or crystalline precipitates). Further, it will be understood that while the compositions are described in terms of an as-batched state, one having ordinary skill in the art will recognize which constituents of the article 10 may volatize in the melting process (i.e., and therefore be less present in the article 10 relative to the as-batched composition) and others which will not.

According to various examples, the article 10 may include Al₂O₃, SiO₂, B₂O₃, WO₃, MO₃, SnO₂, R₂O where R₂O is one or more of Li₂O, Na₂O, K₂O, Rb₂O and Cs₂O, RO where RO is one or more of MgO, CaO, SrO, BaO and ZnO and a number of dopants (e.g., F, P₂O₅, etc.). Unless otherwise noted, glass compositions correspond to as-batched mole percentage (mol %) in a crucible for melting.

The article 10 may have from 40 mol % to 80 mol % SiO₂, or from 45 mol % to 75 mol %, or from 50 mol % to 75 mol % SiO₂ or from 50 mol % to 56 mol % SiO₂. For example, the article 10 may have 42 mol %, 44 mol %, 46 mol %, 48 mol %, 50 mol %, 52 mol %, 54 mol %, 56 mol %, 58 mol %, 60 mol %, 62 mol %, 64 mol %, 66 mol %, 68 mol %, 70 mol %, 72 mol %, 74 mol %, 76 mol % or 78 mol % SiO₂. It will be understood that any and all values and ranges between the above noted ranges of SiO₂ are contemplated.

The article 10 may include from 1 mol % to 15 mol % Al₂O₃, or from 5 mol % to 15 mol % Al₂O₃, or from 7 mol % to 15 mol % Al₂O₃, or from 7 mol % to 12 mol % Al₂O₃, or from 10 mol % to 12 mol % Al₂O₃. For example, the article 10 may have 2 mol %, 3 mol %, 4 mol %, 5 mol %, 6 mol %, 7 mol %, 8 mol %, 9 mol %, 10 mol %, 11 mol %, 12 mol %, 13 mol % or 14 mol % Al₂O₃. It will be understood that any and all values and ranges between the above noted ranges of Al₂O₃ are contemplated.

The article 10 includes WO₃ and optionally includes MoO₃. The combined amount of WO₃ and MoO₃ is referred to herein as “WO₃ plus MoO₃” where it is understood that “WO₃ plus MoO₃” refers to WO₃ alone, or a combination of WO₃ and MoO₃. For example, WO₃ plus MoO₃ may be from 1 mol % to 18 mol %, or from 2 mol % to 10 mol %, or from 3.5 mol % to 8 mol %, or from 3 mol % to 6 mol %. With respect to WO₃, the article 10 may have from 1 mol % to 15 mol % WO₃, or from 1 mol % to 7 mol % WO₃, or from 2 mol % to 4 mol % WO₃. For example, the article may have 1 mol %, 2 mol %, 3 mol %, 4 mol %, 5 mol %, 6 mol %, 7 mol %, 8 mol %, 9 mol %, 10 mol %, 11 mol %, 12 mol %, 13 mol %, 14 mol % WO₃. With respect to MoO₃, the article 10 may have from 0 mol % to 15 mol % MoO₃, or from 0 mol % to 7 mol % MoO₃, or from 0 mol % to 4 mol % MoO₃. For example, the article may have 1 mol %, 2 mol %, 3 mol %, 4 mol %, 5 mol %, 6 mol %, 7 mol %, 8 mol %, 9 mol %, 10 mol %, 11 mol %, 12 mol %, 13 mol %, 14 mol % MoO₃. It will be understood that any and all values and ranges between the above noted ranges of WO₃, WO₃ plus MoO₃, and optional MoO₃ amounts are contemplated.

The article 10 may include from 5 mol % to 50 mol % B₂O₃, or from 5 mol % to 25 mol % B₂O₃, or from 10 mol % to 20 mol % B₂O₃, or from 10 mol % to 15 mol % B₂O₃. It will be understood that any and all values and ranges between the above noted ranges of B₂O₃ are contemplated.

The article 10 further includes at least one alkali metal oxide. The alkali metal oxide may be represented by the chemical formula R₂O where R₂O is one or more of Li₂O, Na₂O, K₂O, Rb₂O, Cs₂O and/or combinations thereof. The article 10 may have R₂O from 1.1 mol % to 16 mol %, or from 8 mol % to 16 mol % or from 11.1 mol % to 16.1 mol % R₂O. For example, the article 10 may have 1 mol %, 1.1 mol %, 2 mol %, 3 mol %, 4 mol %, 5 mol %, 6 mol %, 7 mol %, 8 mol %, 9 mol %, 10 mol %, 11 mol %, 12 mol %, 13 mol %, 14 mol %, 15 mol %, 16 mol %, or 16.1 mol % R₂O. It will be understood that any and all values and ranges between the above noted ranges of R₂O are contemplated.

The article 10 has an alkali content such that R₂O minus Al₂O₃ (i.e., the difference between the amount of R₂O and Al₂O₃) ranges from +0.1 mol % to +4 mol %, or from +0.25 mol % to +2 mol %, or from +0.5 mol % to +4 mol %, or from +1 mol % to +4 mol %, or from +1 mol % to +3 mol %, or from +1.1 mol % to +2 mol %. It will be understood that any and all values and ranges between the above noted ranges of R₂O minus Al₂O₃ are contemplated. The difference in R₂O and Al₂O₃ specified herein influences the availability of excess alkali cations to interact with tungsten oxide, thereby modulating or otherwise controlling the formation of alkali tungsten bronzes, e.g. non-stoichiometric tungsten sub-oxides (MₓWO₃ crystals with x>0.3) and stoichiometric alkali tungstates (e.g., Na₂WO₄). Without being bound by theory, the excess alkali in the glass of article 10 enables more of it to intercalate into the tungsten crystal to form higher dopant concentration bronze crystals, which can produce further color changes upon various levels of crystallization (e.g., through post-melt heat treatments). Put another way, the excess alkali levels can allow greater variations in the MₓWO₃ crystal stoichiometry, resulting in more significant shifts in band gap energy which is manifested in changes in absorbance (i.e., color changes).

The article 10 may include at least one alkaline earth metal oxide and/or ZnO. The alkaline earth metal oxide may be represented by the chemical formula RO where RO is one or more of MgO, CaO, SrO, and BaO. The article 10 may include RO from 0 mol % to 5 mol % RO, or from 0 mol % to 3 mol % RO, or from 0 mol % to 2 mol % RO, or from 0 mol % to 1 mol % RO, or from 0.01 mol % to 1 mol % RO, or from 0.05 mol % to 0.5 mol % RO. The article 10 may include ZnO from 0 mol % to 5 mol % ZnO, or from 0 mol % to 3 mol % ZnO, or from 0 mol % to 1 mol % ZnO. It will be understood that any and all values and ranges between the above noted ranges of RO and ZnO are contemplated. According to various examples, the amount of R₂O may be greater than the amount of RO and/or ZnO. Further, the article 10 may be free of RO and/or ZnO.

The article 10 also includes SnO₂, from 0.01 mol % to 1 mol % SnO₂, or from 0.05 mol % to 0.4 mol % SnO₂, or from 0.1 mol % to 0.3 mol % SnO₂, or from 0.15 mol % to 0.3 mol % SnO₂. For example, the article 10 can include 0.01 mol % SnO₂, 0.02 mol % SnO₂, 0.03 mol % SnO₂, 0.04 mol % SnO₂, 0.05 mol % SnO₂, 0.06 mol % SnO₂, 0.07 mol % SnO₂, 0.08 mol % SnO₂, 0.09 mol % SnO₂, 0.1 mol % SnO₂, 0.5 mol % SnO₂, and 1 mol % SnO₂. It will be understood that any and all values and ranges between the above noted ranges of SnO₂ are contemplated. Without being bound by theory, the tin oxide levels in article 10 and the compositions of the present disclosure can play an important role in the partial reduction of the tungsten bronze crystal (e.g., with some degree of synergy with the excess alkali content in the compositions), which is a necessary component to obtaining further stoichiometry variations (i.e., larger x values in the MₓWO₃ non-stoichiometric crystals, which require more W⁶⁺ to be reduced to W⁵⁺).

According to various examples the article 10 can be doped with P (in the form of P₂O₅) and/or F (in the form of F⁻ ions). For example, the article 10 can include from 0 mol % to 3 mol % P₂O₅, or from 0 mol % to 2 mol % P₂O₅, or from 0 mol % to 1.5 mol % P₂O₅. The article 10 can also include from 0 mol % to 15 mol % F, or from 1 mol % to 10 mol %, or from 3 mol % to 7 mol % F. Further, any and all values and ranges between the above-noted ranges of P₂O₅ and/or F are contemplated for use in article 10 and the compositions of the disclosure. Without being bound by theory, articles 10 containing P₂O₅ and/or F can be ‘softer’ from a viscosity standpoint as these dopants can be added at the expense of some amount of SiO₂. Further, such ‘softer’ compositions can enable increased alkali metal oxides partitioning into the W-containing crystals as there is less SiO₂ to compete with the alkali metal oxides. Further, the increased viscosity curve associated with these ‘softer’ compositions can also influence the rate of diffusion of the alkali metal oxides into the tungsten crystals. With increased alkali metal oxide partitioning into the W-containing crystals, additional color-changing effects can be obtained with one composition through varying heat treatments.

In various examples, the article 10 is substantially free of Au, Ag, V and Cu. Unless otherwise noted herein, the term “substantially free” means that the specified element or constituent is not intentionally included in the article 10 and any measurable amounts that are present in the article 10 are present at <500 ppm. The articles 10 that are substantially free of Au, Ag, V and Cu, while retaining the aspects of varying chromaticity of the disclosure, can be fabricated with relatively low batch costs in terms of processing and raw materials. In other examples, the article 10 may include limited amounts of Au, Ag, V and/or Cu. For example, the article 10 may also include from 0.01 mol % to 1.5 mol % Cu, or from 0.05 mol % to 1.0 mol % Cu, or from 0.1 mol % to 0.5 mol % Cu. The article 10 may include from 0.0001 mol % V₂O₅, or from 0.0005 mol % to 0.5 mol % V₂O₅, or from 0.001 mol % to 0.1 mol % V₂O₅ or from 0.001 mol % to 0.005 V₂O₅. The article 10 may include from 0.05 mol % to 1.5 mol % Ag, or from 0.1 mol % to 1.0 mol % Ag or from 0.25 mol % to 0.6 mol % Ag. It will be understood that any and all values and ranges between the above noted ranges of SnO₂, Cu, V₂O₅ or Ag are contemplated. It will also be understood that Ag, Au, V and/or Cu may exist within the article 10 at any oxidation state and/or in a combination of oxidation states in the above noted mol % values.

According to various examples, the article 10 can further include at least one dopant selected from the group consisting of H, Cu, Au, V, Ag, In, Tl, La, Cr, Mn, Fe, Co, Ni, Se, Nb, Mo, Tc, Ru, Rh, Pd, Cd, Te, Ta, Re, Os, Ir, Pt, Ti, Pb, Bi, Ce, Pr, Nd, Sm, Eu, Gd, Tb, Dy, Ho, Er, Tm, U, Yb, and/or Lu to alter the ultraviolet, visual, color and/or near-infrared absorbance. The dopants may have concentration of from 0.0001 mol % to 1.0 mol % within the glass composition.

It will be understood that each of the above noted compositions and composition ranges for SiO₂, Al₂O₃, WO₃, MoO₃, WO₃ plus MoO₃, B₂O₃, R₂O, RO, P₂O₅, F, SnO₂, and dopants may be used with any other composition and/or composition range of the other constituents of the glass as outlined herein. For example, Tables 1, 2 and 3 provide exemplary composition ranges of the article 10 in an as-batched mol %.

TABLE 1
Exemplary Ag-free polychromatic W
& mixed W/Mo bronze compositions

| Constituent | Min. | Max. |
|---|---|---|
| SiO₂ | 40 | 80 |
| Al₂O₃ | 1 | 15 |
| B₂O₃ | 5 | 50 |
| R₂O | 0 | 15 |
| RO | 0 | 2 |
| P₂O₅ | 0 | 3 |
| F | 0 | 15 |
| MoO₃ | 0 | 15 |
| WO₃ | 1 | 15 |
| SnO₂ | 0.01 | 1 |
| MoO₃ plus WO₃ | 1 | 18 |
| R₂O minus Al₂O₃ | +0.1 | +4 |

TABLE 2
Exemplary Ag-free polychromatic W
& mixed W/Mo bronze compositions

| Constituent | Min. | Max. |
|---|---|---|
| SiO₂ | 45 | 75 |
| Al₂O₃ | 7 | 15 |
| B₂O₃ | 5 | 25 |
| R₂O | 7 | 14 |
| RO | 0.01 | 1 |
| P₂O₅ | 0 | 2 |
| F | 1 | 10 |
| MoO₃ | 0 | 7 |
| WO₃ | 1 | 7 |
| SnO₂ | 0.05 | 0.4 |
| MoO₃ plus WO₃ | 2 | 10 |
| R₂O minus Al₂O₃ | +1 | +3 |

TABLE 3
Exemplary Ag-free polychromatic W
& mixed W/Mo bronze compositions

| Constituent | Min. | Max. |
|---|---|---|
| SiO₂ | 50 | 56 |
| Al₂O₃ | 10 | 12 |
| B₂O₃ | 10 | 15 |
| R₂O | 9 | 12 |
| RO | 0.05 | 0.5 |
| P₂O₅ | 0 | 1.5 |
| F | 3 | 7 |
| MoO₃ | 0 | 4 |
| WO₃ | 2 | 4 |
| SnO₂ | 0.1 | 0.3 |
| MoO₃ plus WO₃ | 3 | 6 |
| R₂O minus Al₂O₃ | +1.1 | +2 |

Formation in conventional tungsten- or mixed tungsten molybdenum-containing alkali glasses has been hampered by the separation of the melt constituents during the melting process. The separation of the glass constituents during the melting process resulted in a perceived solubility limit of alkali tungstate within the molten glass, and therefore of articles cast from such melts. Conventionally, when a tungsten, molybdenum, or mixed tungsten-molybdenum melt was even slightly peralkaline (e.g., R₂O minus Al₂O₃=0.25 mol % or greater), the melted borosilicate glass formed both a glass and a dense liquid second phase. While the concentration of the alkali tungstate second phase could be minimized by thorough mixing, melting at a high temperature, and employing a small batch size (˜1000 g), it could not be fully eliminated leading to formation of a deleterious second crystalline phase. It is believed that the formation of this alkali tungstate phase occurs in the initial stages of the melt, where tungsten oxide and the optional molybdenum oxide reacts with “free” or “unbound” alkali carbonates. Due to the high density of alkali tungstate and alkali molybdate relative to the borosilicate glass that is formed, it rapidly segregates and/or stratifies, pooling at the bottom of the crucible and does not rapidly solubilize in the glass due to the significant difference in density. As the R₂O constituents may provide beneficial properties to the glass composition, simply decreasing the presence of the R₂O constituents within the melt may not be desirable. As the tungsten segregates, it is difficult to saturate the glass with it, and accordingly, it is difficult to get it to crystallize from the glass and form the precipitates as described herein.

It has been discovered that a homogenous single-phase W- or mixed W- and Mo-containing peralkaline melt may be obtained through the use of “bound” alkalis. For purposes of this disclosure, “bound” alkalis are alkali elements which are bonded to oxygen ions which are bound to aluminum, boron, and/or silicon atoms, while “free” or “unbound” alkalis are alkali carbonates, nitrates, or sulfates, which are not bound to an oxygen ion already bound to silicon, boron, or aluminum atoms. Exemplary bound alkalis may include feldspar, nepheline, borax, spodumene, other sodium or potassium feldspars, alkali-aluminum-silicates and/or other oxide compositions containing an alkali and one or more aluminum and/or silicon atoms. By introducing the alkali in the bound form, the alkalis may not react with the W and optional Mo present in the melt to form the dense alkali tungstate and/or alkali molybdate liquid. Moreover, this change in batch material may allow the melting of strongly peralkaline compositions (e.g., R₂O—Al₂O₃=2.0 mol % or more) without the formation of an alkali tungstate and/or alkali molybdate second phase. This has also allowed the melt temperature and mixing method to be varied and still produce a single-phase homogenous glass. It will be understood that as the alkali tungstate phase and the borosilicate glass are not completely immiscible, prolonged stirring may also allow mixing of the two phases to cast a single phase article.

Once the glass melt is cast and solidified into the glass state article, the article 10 may be annealed, heat treated or otherwise thermally processed to form or modify a crystalline phase within the article 10. Accordingly, the article 10 may be transformed from the glass state to the glass-ceramic state. The crystalline phase of the glass-ceramic state may take a variety of morphologies. According to various examples, the crystalline phase is formed as a plurality of precipitates within the heat treated region of the article 10. As such, the precipitates may have a generally crystalline structure. The glass-ceramic state may include two or more crystalline phases.

As used herein, “a crystalline phase” refers to an inorganic material within the articles of the disclosure that is a solid composed of atoms, ions or molecules arranged in a pattern that is periodic in three dimensions. Further, “a crystalline phase” as referenced in this disclosure, unless expressly noted otherwise, is determined to be present using the following method. First, powder x-ray diffraction (“XRD”) is employed to detect the presence of crystalline precipitates. Second, Raman spectroscopy (“Raman”) is employed to detect the presence of crystalline precipitates in the event that XRD is unsuccessful (e.g., due to size, quantity and/or chemistry of the precipitates). Optionally, transmission electron microscopy (“TEM”) is employed to visually confirm or otherwise substantiate the determination of crystalline precipitates obtained through the XRD and/or Raman techniques. In certain circumstances, the quantity and/or size of the precipitates may be low enough that visual confirmation of the precipitates proves particularly difficult. As such, the larger sample size of XRD and Raman may be advantageous in sampling a greater quantity of material to determine the presence of the precipitates.

The crystalline precipitates may have a generally rod-like or needle-like morphology. The precipitates may have a longest length dimension of from 1 nm to 500 nm, or from 1 nm to 400 nm, or from 1 nm to 300 nm, or from 1 nm to 250 nm, or from 1 nm to 200 nm, or from 1 nm to 100 nm, or from 1 nm to 75 nm, or from 1 nm to 50 nm, or from 5 nm to 50 nm, or from 1 nm to 25 nm, or from 1 nm to 20 nm, or from 1 nm to 10 nm. The size of the precipitates may be measured using Electron Microscopy. For purposes of this disclosure, the term “Electron Microscopy” means visually measuring the longest length of the precipitates first by using a scanning electron microscope, and if unable to resolve the precipitates, next using a transmission electron microscope. As the crystalline precipitates may generally have a rod-like or needle-like morphology, the precipitates may have a width of from 5 nm to 50 nm, or from 2 nm to 30 nm, or from 2 nm to 10 nm, or from 2 nm to 7 nm. It will be understood that the size and/or morphology of the precipitates may be uniform, substantially uniform or may vary. Generally, peraluminous compositions of the article 10 may produce precipitates having a needle-like shape with a length of from 100 nm to 250 nm and a width of from 5 nm to 30 nm. Peraluminous compositions are compositions that have a molecular proportion of aluminium oxide higher than the combination of sodium oxide, potassium oxide and calcium oxide. Peralkaline compositions of the article 10 may produce needle-like precipitates having a length of from 10 nm to 30 nm and a width of from 2 nm to 7 nm. Ag, Au and/or Cu containing examples of the article 10 may produce rod-like precipitates having a length of from 2 nm to 20 nm and a width, or diameter, of from 2 nm to 10 nm. A volume fraction of the crystalline phase in the article 10 may range from 0.001% to 20%, or from 0.001% to 15%, or from 0.001% to 10%, or from 0.001% to 5%, or from 0.001% to 1%.

The relatively small size of the precipitates may be advantageous in reducing the amount of light scattered by the precipitates leading to high optical clarity of the article 10 when in the glass-ceramic state. As will be explained in greater detail below, the size and/or quantity of the precipitates may be varied across the article 10 such that different portions of the article 10 may have different optical properties. For example, portions of the article 10 where the precipitates are present may lead to changes in the absorbance, color, reflectance and/or transmission of light, as well as the refractive index as compared to portions of the article 10 where different precipitates (e.g., size and/or quantity) and/or no precipitates are present.

The precipitates may be composed of tungsten oxide or tungsten oxide and molybdenum oxide. The crystalline phase includes an oxide, from 0.1 mol % to 100 mol % of the crystalline phase, of at least one of: (i) W, (ii) Mo+W, (iii) W and an alkali metal cation, and (iv) Mo+W and an alkali metal cation. Without being bound by theory, it is believed that during thermal processing (e.g., heat treating) of the article 10, tungsten and the optional molybdenum cations agglomerate to form crystalline precipitates thereby transforming the glass state into the glass-ceramic state. The molybdenum and/or tungsten present in the precipitates may be reduced, or partially reduced. For example, the molybdenum and/or tungsten within the precipitates may have an oxidation state of between 0 and +6, or from +4 and +6, or from +5 and +6. According to various examples, the molybdenum and/or tungsten may have a +6 oxidation state. For example, the precipitates may have the general chemical structure of WO₃ and/or MoO₃. The precipitates may be known as non-stoichiometric tungsten suboxides, non-stoichiometric molybdenum suboxides, “molybdenum bronzes” and/or “tungsten bronzes.” One or more of the above-noted alkali metals and/or dopants may be present within the precipitates. Tungsten and/or mixed tungsten molydbenum bronzes are a group of non-stoichiometric tungsten and/or molybdenum sub-oxides that takes the general chemical form of MₓWO₃ or MₓMoO₃, where M═H, Li, Na, K, Rb, Cs, Ca, Sr, Ba, Zn, Ag, Au, Cu, Sn, Cd, In, Tl, Pb, Bi, Th, La, Pr, Nd, Sm, Eu, Gd, Dy, Ho, Er, Tm, Yb, Lu, and U, and where 0<x<1. The structures MₓWO₃ and MₓMoO₃ are considered to be a solid state defect structure in which holes (vacancies and/or interstices) in a reduced WO₃ or MoO₃ network are randomly occupied by M atoms, which are dissociated into M⁺ cations and free electrons. Depending on the concentration of “M,” the material properties can range from metallic to semi-conducting, thereby allowing a variety of optical absorption and electronic properties to be tuned. Further, the structure of these bronzes is considered to be a solid state defect structure in which M′ cations intercalate into holes or channels of the oxide host and disassociate into M+ cations and free electrons. In turn, as x is varied, these materials can exist as a broad sequence of solid phases, with definite and wide ranges of homogeneity. Further, depending on the amount of alkali (e.g., sodium) in the bronze crystal, the color can be tuned through nearly the entire visible spectrum (e.g., green, grey, dark blue, royal blue, purple, red, orange and yellow).

A portion, a majority, substantially all or all of the article 10 may be thermally processed to form the precipitates. Thermal processing techniques may include, but are not limited to, a furnace (e.g., a heat treating furnace), a laser and/or other techniques of locally and/or bulk heating of the article 10. While undergoing thermal processing, the crystalline precipitates internally nucleate within the article 10 in a homogenous manner where the article 10 is thermally processed to form the glass-ceramic state. As such, in some examples, the article 10 may include both glass and glass-ceramic portions. In examples where the article 10 is thermally processed in bulk (e.g., the whole article 10 is placed in a furnace), the precipitates may homogenously form throughout the article 10. In other words, the precipitates may exist from a surface of the article 10 throughout the bulk of the article 10 (i.e., greater than 10 μm from the surface). In examples where the article 10 is thermally processed locally (e.g., via a laser), the precipitates may only be present where the thermal processing reaches a sufficient temperature (e.g., at the surface and into the bulk of the article 10 proximate the heat source). It will be understood that the article 10 may undergo more than one thermal processing to produce the precipitates. Additionally or alternatively, thermal processing may be utilized to remove and/or alter precipitates which have already been formed (e.g., as a result of previous thermal processing). For example, thermal processing may result in the decomposition of precipitates.

According to various examples, the article 10 may be polychromatic. For purposes of this disclosure, the term “polychromatic” means a material which is capable of exhibiting different colors based on thermal treatments applied to it. WO₃ has no absorption of NIR wavelengths and only weak absorbance of visible wavelengths due to its wide band gap (e.g., 2.62 eV) and lack of free carriers (e.g., electrons). With the insertion (termed ‘intercalation’) of dopant ions (e.g., NH₄⁺, Li⁺, Na⁺, K⁺, Rb⁺, Cs⁺, etc.), part of tungsten atoms in WO₃ are reduced from W⁺⁶ to W⁺⁵, resulting in free electrons within the crystal. These electrons occupy conduction bands (e.g., free electrons) and localized states in band gaps (e.g., trapped electrons). As a result, the doped WO₃ (tungsten bronzes) acquires the ability of blocking NIR over a wide wavelength range (e.g., λ>1100 nm) by absorbing NIR whose photon energy is lower than 0.7 eV through localized surface plasmon resonance and insulating NIR whose photon energy is near 1.4 eV through a small polaron mechanism. The tungsten bronzes of the disclosure can also exhibit strong UV and VIS absorption. It will be understood that the same manner of doping and its effects are present in compositions with both WO₃ and MoO₃.

Some colored glass compositions utilize transition metal dopants such as Ag, Au, V and/or Cu to form nanoscale metallic precipitates of varying size and shape to generate visible absorbance (i.e., color). However, unlike such colored glasses, the optical absorbance of the tungsten and mixed tungsten molybdenum bronzes of the disclosure are formed by the nucleation and growth of alkali-doped tungsten and molybdenum sub-oxides, referred to herein as ‘bronzes’. These polychromatic compositions are specifically designed to be modifier rich (i.e., they have a positive R₂O—Al₂O₃ value) and also have appreciable tin oxide levels. The excess alkali in the glass allows more of it intercalate into the tungsten/molybdenum crystal to form higher dopant concentrations in these bronze crystals, which leads to further polychromatic effects. Accordingly, the glass compositions of the disclosure are not necessarily reliant on the use of Ag, Au, V and/or Cu for color-tuning or polychromatic capabilities. Further, the tin oxide in the glass compositions of the disclosure can enable partial reduction of the tungsten- and mixed tungsten and molybdenum-containing crystals, which can facilitate the development of higher stoichiometry bronzes (e.g., MₓWO₃ with larger x values necessitating a larger amount of W⁶⁺ compared to W⁵⁺). With increased variance of tungsten and mixed tungsten/molybdenum bronze stoichiometry, increasing color-changing effects can be obtained through heat treatment of these compositions. Optional additions of fluorine and/or phosphorous can also make these compositions ‘softer’, which can further increase the rate of alkali diffusion into the tungsten or mixed tungsten molybdenum bronze crystals, especially during heat treatment processing. As such, the tungsten and mixed tungsten/molybdenum bronzes of the disclosure can be widely varied and tuned in terms of color (i.e., optical absorbance) relative to conventional glass and glass-ceramic compositions that primarily employ Ag, Au, Cu and/or V as dopants, each of which significantly increases cost.

In view of the above discussion, it is believed that the origin of color tunability in these polychromatic articles 10 is due to the change in the band gap energy of the doped tungsten and/or molybdenum oxide precipitates, arising from the concentration of alkali cations that intercalate into the precipitates to form a pure alkali, mixed alkali-metal, and/or a pure metal tungsten and/or molybdenum bronzes of varying stoichiometry. Changes in the band gap energy of the precipitates are due to their stoichiometry, and are largely independent of crystallite size. Therefore doped MₓWO₃ or MₓMoO₃ precipitates can remain the same size and/or shape, yet could provide the article 10 with many different colors depending on the dopant “M” identity and concentration “x”. Further, it is believed that the thermal processing time and temperature control the stoichiometry “x” and possibly the identity of “M.” For example, at relatively low temperatures, blue and green colors were observed that are characteristic of a MₓWO₃ and/or MₓMoO₃ bronze, where M=an alkali and 0.1<x<0.4. At temperatures above where these ‘blue bronzes’ form, colors such as yellow, red, and orange are formed, that suggest that “x” in MₓWO₃ is >0.4 and approaches 1 with increasing heat treatment time.

In some examples of the compositions of the disclosure, the polychromatic nature, or color tunability, can be a function of “M” in MₓWO₃ and MₓMoO₃ when M is something else other than sodium (i.e., M≠Na), or M is a combination of species: H, Li, Na, K, Rb, Cs, Mg, Ca, Sr, Sn, P, S, Ti, V, Cr, Mn, Fe, Co, Ni, Cu, Ga, Se, Zr, Nb, Ru, Rh, Pd, Ag, Cd, In, Sb, Te, La, Ce, Pr, Nd, Sm, Eu, Gd, Tb, Dy, Ho, Er, Tm, Yb, Lu, Ta, Os, Ir, Pt, Au, Tl, Pb, Bi, and/or U. The resultant color is due to the total dopant concentration x and also the identities of M (i.e., species with different electron densities, but the same charge can produce different optical responses). As will be understood, some of the species listed can only intercalate up to some x value (i.e., a narrower range of x than 0≤x≤1). This may be due to the cation size and charge. For example, red, yellow and/or orange colors can be obtained from non-stoichiometric tungstate compounds containing divalent cations M′ where M′ is one of MgO, CaO, SrO, BaO, ZnO, of the form M′_{2-X}WO₄ (where 0<x<1).

The thermal processing of the article 10 to develop the precipitates and/or generate color may be accomplished in a single step or through multiple steps. For example, the generation of colors exhibited by the article 10 (e.g., which starts with the formation of a WO₃ and/or MoO₃ precipitates followed by the partial reduction of that crystallite with the simultaneous intercalation of a dopant species (e.g., alkali metal cations into the crystal)) can be completed in a single heat treatment immediately after the article 10 is formed, or at a later point. For example, the article 10 may be cast and then processed into a final form (e.g., lens blanks or other optical or aesthetic elements) and then annealed at a temperature just below where color is generated (e.g., intercalation of the alkali metal ions into the precipitates). This annealing may start the clustering of WO₃ and/or MoO₃, and then a secondary thermal processing may occur at an elevated temperature to allow further crystallization and the partial reduction of the WO₃ and/or MoO₃ crystals and intercalation of alkali metal ions and/or other species to generate color.

The thermal processing of the article 10, which generates the precipitates and/or intercalates the dopants into the precipitates, may occur under a variety of times and temperatures. It will be understood that thermal processing of the article 10 is carried out in air unless otherwise noted. In examples where the article 10 is thermally processed in a furnace, the article 10 may be placed in the furnace at room temperature with a controlled ramping in temperature and/or may be “plunged” into a furnace already at an elevated temperature. The thermal processing may occur at a temperature of from 400° C. to 1000° C. For example, the second thermal processing may take place at a temperature of 400° C., or 425° C., or 450° C., or 475° C., or 500° C., or 505° C., or 510° C., or 515° C., or 520° C., or 525° C., or 530° C., or 535° C., or 540° C., or 545° C., or 550° C., or 555° C., or 560° C., or 565° C., or 570° C., or 575° C., or 580° C., or 585° C., or 590° C., or 595° C., or 600° C., or 605° C., or 610° C., or 615° C., or 620° C., or 625° C., or 630° C., or 635° C., or 640° C., or 645° C., or 650° C., or 655° C., or 660° C., or 665° C., or 670° C., or 675° C., or 680° C., or 685° C., or 690° C., or 695° C., or 700° C.

The thermal processing may be carried out for a time period of from 1 second to 24 hours. For example, the thermal processing may be carried out for 1 second, or 30 seconds, or 45 seconds, or 1 minute, or 2 minutes, or 5 minutes, or 10 minutes, or 15 minutes, or 20 minutes, or 25 minutes, or 30 minutes, or 35 minutes, or 40 minutes, or 45 minutes, or 50 minutes, or 55 minutes, or 60 minutes, or 65 minutes, or 70 minutes, or 75 minutes, or 80 minutes, or 85 minutes, or 90 minutes, or 95 minutes, or 100 minutes, or 105 minutes, or 110 minutes, or 115 minutes, or 120 minutes, or 125 minutes, or 130 minutes, or 135 minutes, or 140 minutes, or 145 minutes, or 150 minutes, or 155 minutes, or 160 minutes, or 165 minutes, or 170 minutes, or 175 minutes, or 180 minutes, or 185 minutes, or 190 minutes, or 195 minutes, or 200 minutes, or 205 minutes, or 210 minutes, or 215 minutes, or 220 minutes, or 225 minutes, or 230 minutes, or 235 minutes, or 240 minutes, or 245 minutes, or 250 minutes, or 255 minutes, or 300 minutes, or 350 minutes, or 400 minutes, or 450 minutes, or 500 minutes. It will be understood that thermal processing may be carried out for significantly longer times upwards of 6 hours or more, 7 hours or more, 8 hours or more, 9 hours or more, 10 hours or more, 11 hours or more, 12 hours or more, 13 hours or more, 14 hours or more or 15 hours or more.

In some examples, the article 10 may then be cooled to a lower temperature at a rate of 0.1° C. per minute, or 1° C. per minute, or 2° C. per minute, or 3° C. per minute, or 4° C. per minute, or 5° C. per minute, or 6° C. per minute, or 7° C. per minute, or 8° C. per minute, or 9° C. per minute or 10° C. per minute. The lower temperature may be from room temperature (e.g., 23° C.) to 500° C. For example, the lower temperature may be 23° C., 50° C., 75° C., 100° C., 125° C., 150° C., 175° C., 200° C., 225° C., 250° C., 275° C., 300° C., 325° C., 350° C., 375° C., 400° C., or 425° C., or 450° C., or 470° C. or 500° C. It will be understood that the article 10 may undergo a multistage thermal processing using one or more of the above noted time and temperatures.

It will be understood that any and all values and ranges for time and temperature between the values provided for the thermal processing are contemplated. Further, it will be understood that any combination of the above noted times and temperatures are contemplated.

As explained above, additionally or alternatively to the use of a furnace, the article 10 may be thermally processed through the use of a laser and/or other localized heat source. Such an example may be advantageous in producing a localized color or polychromatic effect. The laser and/or localized heat source may supply sufficient thermal energy to create the precipitates and/or intercalate one or more alkali metal ions into the precipitates to generate localized color. The laser and/or other heat source may be rastered or guided across the article 10 to preferentially create color and/or varied optical properties across the article 10. The intensity and/or speed of the laser and/or localized heat source may be adjusted as it is moved across the article 10 such that various portions of the article 10 exhibit different colors. Such features may be advantageous in creating indicia, symbols, text, numbers and/or pictures in the article 10.

As explained above, depending on the composition of the article 10 and the thermal processing it undergoes, the article 10 may exhibit a variety of colors. Specifically, the article 10 may exhibit the following colors: blue, green, brown, amber, yellow, orange, red, oxblood red, shades of neutral gray and bronze-brown colors and/or combinations thereof. It will be understood that any of these colors and/or color combinations may be generated in bulk across the article 10 and/or in localized portions of the article 10 as explained above. The color of the article may be expressed in terms of a three-dimensional L*a*b* color space where L* is lightness and a* and b* for the color opponents green-red and blue-yellow, respectively. Additionally or alternatively, the color of the article 10 may also be expressed in values of X and Y where Y is luminance and X is a mix (e.g., a linear combination) of cone response curves chosen to be nonnegative. Unless otherwise specified, the L*, a*, b* and X, Y color coordinates, with specular component included, are collected under D65-2° illumination with an X-Rite colorimeter in transmittance mode on polished 0.5 mm thick flats cut from rolled sheet after heat treatment. In other words, the color coordinates are transmitted color coordinates. The article 10 may exhibit an L* value of from 6 to 90, or from 6 to 85, or from 4 to 86, or from 14 to 90, or from 21 to 88, or from 4.5 to 81, or from 39 to 90, or from 8 to 90, or from 15 to 91, or from 28 to 92, or from 16 to 81, or from 49 to 89, or from 41 to 96 or from 15.6 to 96. The article 10 may exhibit an a* value from −18.6 to 49, or from −13 to 41, or from −9 to 38, or from −14 to 31, or from −11 to 36, or from −12 to 29 or from −12 to 26. The article 10 may exhibit a b* value of from −7.8 to 53.5, or from −2 to 63, or from 2 to 70, or from 6 to 70, or from 1 to 68, or from 1 to 65, or from 4 to 49, or from 1 to 37, or from 4 to 24 or from 5 to 30. The article 10 may exhibit an X value of from 0.24 to 0.65, or from 0.25 to 0.45, or from 0.3 to 0.4, or from 0.31 to 0.66, or from 0.27 to 0.62, or from 0.29 to 0.66, or from 0.30 to 0.65, or from 0.29 to 0.60, or from 0.31 to 0.57 or from 0.3 to 0.48. The article may also exhibit a minimum X value from 0.25 to 0.45, or from 0.3 to 0.4. The article 10 may exhibit a Y value of from 0.3 to 0.5, or from 0.32 to 0.43, or from 0.34 to 0.40, or from 0.33 to 0.43 or from 0.35 to 0.38, or from 0.35 to 0.41. Further, the article 10 may exhibit a minimum Y value of from 0.3 to 0.5, or from 0.35 to 0.41. It will be understood that all values and ranges between the above noted ranges and values are contemplated for L*, a*, b*, X and Y. Further, it will be understood that any of the L*, a*, b*, X and Y values may be used in conjunction with any of the other L*, a*, b*, X and Y values.

The article 10 may exhibit an absorbance over certain wavelength bands of electromagnetic radiation. The absorbance may be expressed in terms of optical density per millimeter (OD/mm). As understood by those in the art, optical density is the log of the ratio of light intensity exiting the article 10 to light intensity entering the article 10. Absorbance data may be collected using a UV/VIS spectrophotometer in conformance with the measurement rules according to ISO 15368. Over a wavelength range of from 280 nm to 365 nm, the article 10 may have an absorbance of 0.6 OD/mm to greater than 8 OD/mm, or from 1 OD/mm to greater than 8 OD/mm or from 4 OD/mm to greater than 8 OD/mm. For example, the article 10 may have an absorbance over a wavelength of from 280 nm to 380 nm of 0.5 OD/mm or greater, or 1.0 OD/mm or greater, or 1.5 OD/mm or greater, or 2.0 OD/mm or greater, or 2.5 OD/mm or greater, or 3.0 OD/mm or greater, or 3.5 OD/mm or greater, or 4.0 OD/mm or greater, or 4.5 OD/mm or greater, or 5.0 OD/mm or greater, or 5.5 OD/mm or greater, or 6.0 OD/mm or greater, or 6.5 OD/mm or greater, or 7.0 OD/mm or greater, or 7.5 OD/mm or greater, or 8.0 OD/mm or greater, or 8.5 OD/mm or greater, or 9.0 OD/mm or greater, or 9.5 OD/mm or greater or 10.0 OD/mm or greater. It will be understood that any and all values and ranges between the values listed above are contemplated.

Over a wavelength range of from 365 nm to 400 nm, the article 10 may have an absorbance of 0.2 OD/mm to greater than 10 OD/mm, or from 1 OD/mm to greater than 8 OD/mm, or from 1.8 OD/mm to 7.5 OD/mm. For example, the article 10 may have an absorbance over a wavelength of from 365 nm to 400 nm of 0.5 OD/mm or greater, or 1.0 OD/mm or greater, or 1.5 OD/mm or greater, or 2.0 OD/mm or greater, or 2.5 OD/mm or greater, or 3.0 OD/mm or greater, or 3.5 OD/mm or greater, or 4.0 OD/mm or greater, or 4.5 OD/mm or greater, or 5.0 OD/mm or greater, or 5.5 OD/mm or greater, or 6.0 OD/mm or greater, or 6.5 OD/mm or greater, or 7.0 OD/mm or greater, or 7.5 OD/mm or greater, or 8.0 OD/mm or greater, or 8.5 OD/mm or greater, or 9.0 OD/mm or greater, or 9.5 OD/mm or greater or 10.0 OD/mm or greater. It will be understood that any and all values and ranges between the values listed above are contemplated.

Over a wavelength range of from 400 nm to 700 nm, the article 10 may have an absorbance of 0.1 OD/mm to 6 OD/mm, or from 0.1 OD/mm to 0.7 OD/mm, or from 0.1 OD/mm to 4.4 OD/mm, or from 0.2 OD/mm to 1.1 OD/mm, or from 0.2 OD/mm to 0.6 OD/mm, or from 0.6 OD/mm to 4.2 OD/mm. For example, the article 10 may have an absorbance over a wavelength of from 400 nm to 700 nm of 0.5 OD/mm, or 1.0 OD/mm, or 1.5 OD/mm, or 2.0 OD/mm, or 2.5 OD/mm, or 3.0 OD/mm, or 3.5 OD/mm, or 4.0 OD/mm, or 4.5 OD/mm, or 5.0 OD/mm, or 5.5 OD/mm or 6.0 OD/mm. It will be understood that any and all values and ranges between the values listed above are contemplated.

Over a wavelength range of from 365 nm to 2000 nm, the article 10 may have an absorbance of 0.1 OD/mm to 5.7 OD/mm, or from 0.1 OD/mm to 1.2 OD/mm, or from 0.15 OD/mm to 1.1 OD/mm, or from 0.2 OD/mm to 2.2 OD/mm, or from 0.2 OD/mm to 1.5 OD/mm, or from 0.25 OD/mm to 1.1 OD/mm, or from 0.1 OD/mm to 5.2 OD/mm. For example, over a wavelength range of from 700 nm to 2000 nm, the article 10 may have an absorbance of 0.2 OD/mm, or 0.4 OD/mm, or 0.6 OD/mm, or 0.8 OD/mm, or 1.0 OD/mm, or 1.2 OD/mm, or 1.4 OD/mm, or 1.6 OD/mm, or 1.8 OD/mm, or 2.0 OD/mm, or 2.2 OD/mm, or 2.4 OD/mm, or 2.6 OD/mm, or 2.8 OD/mm, or 3.0 OD/mm, or 3.2 OD/mm, or 3.4 OD/mm, or 3.6 OD/mm, or 3.8 OD/mm, or 4.0 OD/mm, or 4.2 OD/mm, or 4.4 OD/mm, or 4.6 OD/mm, or 4.8 OD/mm, or 5.0 OD/mm, or 5.2 OD/mm, or 5.4 OD/mm, or 5.6 OD/mm or 5.8 OD/mm. It will be understood that any and all values and ranges between the values listed above are contemplated.

Over a wavelength range of from 700 nm to 2000 nm, the article 10 may have an absorbance of 0.1 OD/mm to 5.7 OD/mm, or from 0.2 OD/mm to 2.2 OD/mm, or from 0.2 OD/mm to 1.5 OD/mm, or from 0.25 OD/mm to 1.1 OD/mm, or from 0.1 OD/mm to 5.2 OD/mm. For example, over a wavelength range of from 700 nm to 2000 nm, the article 10 may have an absorbance of 0.2 OD/mm, or 0.4 OD/mm, or 0.6 OD/mm, or 0.8 OD/mm, or 1.0 OD/mm, or 1.2 OD/mm, or 1.4 OD/mm, or 1.6 OD/mm, or 1.8 OD/mm, or 2.0 OD/mm, or 2.2 OD/mm, or 2.4 OD/mm, or 2.6 OD/mm, or 2.8 OD/mm, or 3.0 OD/mm, or 3.2 OD/mm, or 3.4 OD/mm, or 3.6 OD/mm, or 3.8 OD/mm, or 4.0 OD/mm, or 4.2 OD/mm, or 4.4 OD/mm, or 4.6 OD/mm, or 4.8 OD/mm, or 5.0 OD/mm, or 5.2 OD/mm, or 5.4 OD/mm, or 5.6 OD/mm or 5.8 OD/mm. It will be understood that any and all values and ranges between the values listed above are contemplated.

The article 10 may exhibit differing transmittances over different wavelength bands of electromagnetic radiation. The transmittance may be expressed in a percent transmittance. Transmittance data may be collected using a UV/VIS spectrophotometer on a sample having a 0.5 mm thickness in conformance with the measurement rules according to ISO 15368. Over a wavelength range of from 280 nm to 380 nm, the article 10 may have transmittance of 0% to 50%, or from 0.01 to 30%, or from 0.01% to 0.91%. For example, the article 10 may have a transmittance over a wavelength of from 280 nm to 365 nm of 0.5%, or 5%, or 10%, or 15%, or 20%, or 25%, or 30%, or 35%, or 40%, or 45%. It will be understood that any and all values and ranges between the values listed above are contemplated.

The article 10 may have a transmittance over a wavelength range of from 365 nm to 400 nm of 0% to 86%, or from 0.8% to 86%, or from 0% to 25% or from 0.02% to 13%. For example, the article 10 may have a transmittance over a wavelength of from 380 nm to 400 nm of 1%, or 5%, or 10%, or 15%, or 20%, or 25%, or 30%, or 35%, or 40%, or 45%, or 50%, or 55%, or 60%, or 65%, or 70%, or 75%, or 80%. It will be understood that any and all values and ranges between the values listed above are contemplated. Transmittance data may be collected using a UV/VIS spectrophotometer on a sample having a 0.5 mm thickness in conformance with the measurement rules according to ISO 15368.

The article 10 may have a transmittance over a wavelength range of from 400 nm to 700 nm of 0% to 95%, or from 0% to 88%, or from 0% to 82%, or from 0% to 70%, or from 0% to 60%, or from 0% to 50%, or from 0% to 40%, or from 0% to 30%, or from 0% to 20%, or from 0% to 10%, or from 5% to 50%, or from 10% to 70%. In some examples having a thickness of 1.9 mm, the article 10 exhibits an average transmittance of at least 7%, at least 10%, at least 15%, or at least 20%, within a wavelength range from 400 nm to 700 nm. It will be understood that any and all values and ranges between or above the values listed above are contemplated. Transmittance data may be collected using a UV/VIS spectrophotometer on a sample having a 0.5 mm thickness in conformance with the measurement rules according to ISO 15368, unless otherwise noted.

The article 10 may exhibit a scattering of from 0.1% to 25% over a wavelength band of 400 nm to 700 nm at a thickness of 1 mm. For example, the article 10 may exhibit a scattering of 25% or less, 24% or less, 23% or less, 22% or less, 21% or less, 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less or 1% or less. Scattering data is collected in conformance with ISO 13696 (2002) Optics and Optical Instruments—Test methods for radiation scattered by optical components.

Various examples of the present disclosure may offer a variety of properties and advantages. It will be understood that although certain properties and advantages may be disclosed in connection with certain compositions, various properties and advantages disclosed may equally be applicable to other compositions.

First, as the compositions of the article 10 disclosed herein differ from the known copper-, silver-, and gold-doped glasses, the color of the articles 10 can be widely tuned without changing composition and successfully meet optical specifications over a number of distinct colors. As such, the family of compositions disclosed herein for the article 10 may offer a practical solution to streamlining colored article production. As explained above, a wide range of optical absorbance may be achieved by varying heat treatment time and temperature after forming. As such, a single tank of glass may be used to continuously produce articles 10 that can be heat treated to multiple specific colors as customer demand dictates (i.e., reducing production down-time, decreasing unusable transition glass). Further, various compositions of the article 10 are also capable of producing a near complete rainbow of colors by varying heat treatment time and temperature across the article 10 (e.g., a rainbow of colors can be produced within a single article). In addition to changes in color, a perceived tint, or transmittance, may be varied across the article 10. As the tint of the article 10 itself may be adjusted, dyed plastic laminates, films, or dyed polycarbonate lenses of conventional articles may be eliminated. Further, as the colors, reflectance and/or tints achieved by the article are a property of the article 10 itself, the article 10 may exhibit greater environmental durability (e.g., abrasion and/or chemical resistance) than conventional articles. In specific applications, the article 10 may be utilized as sunglass lenses (i.e., which may be advantageous as the article 10 may offer a wide variety of colors in addition to absorbing infrared radiation to protect sunglass wearers from heat and the radiation) and/or in automotive or architecture applications (e.g., where gradient fades or multiple colors are desired in the same window pane providing designers a new level of flexibility with respect to multiple colors, transmission, and saturation in a monolithic article 10 all while blocking deleterious ultraviolet and/or infrared radiation thereby decreasing the heating and cooling loads on the cars or buildings they adorn). For example, the article 10 may meet the standards ISO 14 889:2013 & 8980-3 2013, ANSI Z80.3-2001, AS 1067-2003 and ISO 12312-1 : 2013.

Second, the compositions of the article 10 can have a sufficiently high liquidus viscosity such that the article 10 may be capable of fusion forming. With respect to ion-exchanging, ion-exchanging may provide a compressive stress at the selected depth 30 which may increase the durability and/or scratch resistance of the article 10. With respect to fusion forming, the article 10 may be utilized in a double fusion laminate where a transparent tungsten glass, or mixed tungsten molybdenum glass, is employed as a clad material around a substrate. After application as the cladding, the glass cladding may be transformed to the glass-ceramic state. The glass-ceramic cladding of the double fusion laminates may have a thickness of from 50 μm to 200 μm and may have a strong UV and IR attenuation with high average visible transmittance (e.g., from 75% to 85% for automotive windshields and/or architectural glazing), a strong UV and IR attenuation with low visible transmittance (e.g., 5% to 30% for automotive side lights, automotive sunroofs, and privacy glazing) and/or a laminate where the visible and infrared absorbance can be modulated by treatment in a gradient furnace, local heating and/or localized bleaching. Additionally, use of the glass compositions as a cladding provides a novel process to fully leverage the tunable optical properties while simultaneously producing a strengthened monolithic glass ply. Further, the cladding may be applied to a substrate which also has tunable optical properties such that both the core and cladding may be independently tunable.

Third, as the articles 10 may exhibit tunable optical properties (e.g., color, transmittance, etc.) with varying thermal processing, treatment in a gradient furnace or under infrared lamp can produce nearly a complete rainbow of colors within a single piece of material (e.g., which may be desirable for aesthetic purposes such as cell phone or tablet backs). Further, as the thermal processing may be localized (e.g., through use of a laser), the article 10 may be patternable and colorable. For example, a laser-assisted heating and/or cooling process may utilize different wavelengths to produce novel decorative materials and rapidly produce logos and images within the article 10. By optimizing laser power and writing speed, a host of colors can be achieved. Further, laser patterning with multiple wavelengths may be employed to selectively bleach (i.e., remove color and/or tint in selected areas through the dissolution of the precipitates) which may be useful for decoration, gradient absorption, or other unique artistic effects.

Fourth, heating and slumping, or pressing with ceramic or metal plates engraved with text, designs, and or patterns may be used to induce a gradient in color by creating a varied thermal profile in the article 10. For example, by using a heat sink with a design or texture, a varied thermal profile upon cooling of the article 10 could produce a latent image that could be later developed by thermal processing of the article 10.

Fifth, use of a color cell on a continuous melter may be used to introduce trace dopants to the glass-composition of the article 10 as the articles 10 are produced. For example, the article 10 may be doped with V₂O₅ to produce greys and bronze browns and/or Ag to produce blues, greens, ambers, reds, and oranges. This would enable a full complement of colors to be produced with a fixed set of ingredients and allows rapid tank transition between Ag- and V₂O₅-doped articles 10 without a long down time due to a difference in density. Use of the color cell may eliminate the need for a tank transition as on-the-fly doping of the articles 10 may produce neutral greys, bronze browns, blues, greens, ambers, reds, oranges and any combination thereof without any tank transitions (e.g., as the dopants to produce the colors may be mixed as the articles 10 are produced).

Sixth, as the articles 10 may not contain volatile halides, they may be easier and more reproducible to produce. Further, the coloration of the articles 10 may not require ultraviolet exposure and multiple heat-treatments like Joseph glass. As such, all colors can be achieved with a one-step thermal processing by optimizing time and temperature.

Seventh, articles 10 produced from the glass compositions of the present disclosure may be powdered or granulated and added to a variety of materials. For example, the powdered article 10 may be added to a paint, binder, polymeric material (e.g., polyvinyl butyral), sol-gels and/or combinations thereof. Such a feature may be advantageous in imparting one or more of the characteristics (e.g., total transmittance, UV cutoff, infrared absorbance, etc.) of the article 10 to the above mentioned material.

Eighth, the article 10 may readily form different shades of green, which is a difficult color to obtain in many doped glasses comprising Ag, Cu, V and/or Cu.

Ninth, the batch cost of the articles 10, as without appreciable amounts of Ag, Cu, V and C is relatively low, particularly as compared to conventional Ag, Cu, V and/or Cu doped glasses and glass-ceramic compositions.

### EXAMPLES

The following examples represent certain non-limiting examples of the glass-ceramic materials and articles of the disclosure, including the methods of making them.

### Example 1

Referring now to Table 4, a list of exemplary polychromatic tungsten (Exs. 1-1F) and mixed tungsten molybdenum bronze compositions (Exs. 1G and 1H) for an element (e.g., the article 10) is provided. As is evident from the table, Exs. 1, 1D, 1E and 1F are fluorine-containing compositions; and Exs. 1A-1C, 1G and 1H are fluorine-free. These exemplary compositions are provided in as-batched mol %. In this example, the compositions of Table 4 were prepared by weighing the batch constituents, mixing them by turbula or ball mill and melting for 6-32 hours at temperatures between 1300° C. to 1500° C. in Pt crucibles (silica, refractory or Pt/Rh crucibles can also be employed for the compositions of the disclosure). The glasses were then cast onto a metal table to produce an ‘optical pour’ or ‘patty’ of glass. Some melts were cast onto a steel table and then rolled into sheet using a steel roller. The glass was then annealed at temperatures between 380° C. to 570° C.

TABLE 4
Polychromatic Ag-free W and mixed W/Mo bronze ceramic compositions (mol %)

| Constituent | Ex. 1 | Ex. 1A | Ex. 1B | Ex. 1C | Ex. 1D | Ex. 1E | Ex. 1F | Ex. 1G | Ex. 1H |
|---|---|---|---|---|---|---|---|---|---|
| SiO₂ | 55.469 | 66.417 | 64.974 | 64.492 | 55.417 | 55.365 | 55.314 | 67.181 | 67.181 |
| Al₂O₃ | 10.861 | 9.611 | 10.572 | 10.572 | 10.851 | 10.841 | 10.830 | 9.617 | 9.617 |
| B₂O₃ | 12.683 | 9.419 | 9.419 | 9.419 | 12.671 | 12.659 | 12.647 | 9.425 | 9.425 |
| Li₂O | 5.435 | 5.558 | 6.030 | 6.507 | 5.430 | 5.425 | 5.419 | 4.845 | 4.846 |
| Na₂O | 6.638 | 4.999 | 5.008 | 5.011 | 6.632 | 6.625 | 6.619 | 4.997 | 4.997 |
| K₂O | 0.023 | 0.024 | 0.026 | 0.028 | 0.023 | 0.023 | 0.023 | 0.021 | 0.021 |
| MgO | 0.016 | 0 | 0 | 0 | 0.015 | 0.014 | 0.013 | 0 | 0 |
| CaO | 0.191 | 0.080 | 0.080 | 0.080 | 0.191 | 0.190 | 0.190 | 0.019 | 0.019 |
| SnO₂ | 0.143 | 0.048 | 0.048 | 0.048 | 0.238 | 0.333 | 0.428 | 0.048 | 0.048 |
| WO₃ | 3.099 | 3.845 | 3.844 | 3.844 | 3.096 | 3.093 | 3.090 | 1.924 | 0.962 |
| MoO₃ | 0 | 0 | 0 | 0 | 0 | 0 | 0 | 1.923 | 2.885 |
| F⁻ | 5.435 | 0 | 0 | 0 | 5.430 | 5.425 | 5.420 | 0 | 0 |
| R₂O—Al₂O₃ | +1.234 | +0.969 | +0.491 | +0.973 | +1.233 | +1.232 | +1.231 | +0.246 | +0.247 |

Samples of the as-cast compositions of this example were heat treated at times ranging from 5 to 500 minutes at temperatures ranging from 425° C. to 600° C. in ambient air electric ovens. These heat treatments were adjusted in terms of time and temperature to achieve varying levels of optical absorbance across NIR, VIS and UV spectra. Further, the cooling rate was also adjusted in heat treating these samples to obtain particular absorbance profiles, from 1° C./min to much more rapid cooling rates (e.g., removing the sample directly from the oven into an ambient temperature environment while the oven remained at the heat treatment temperature).

To evidence the influence of heat treatment on the polychromatic capability of the compositions of the disclosure, samples of the Ex. 1 composition were heat treated according to the schedule listed below in Table 5 to generate samples Exs. 1-1 through 1-7. As is evident from Table 5, the maximum heat treatment temperatures were 475° C., 510° C., 525° C., and 550° C.; and the hold times at these maximum temperatures were 67.5 minutes, 105 minutes, 112.5 minutes, 168.5 minutes, 170 minutes, and 200 minutes.

TABLE 5
Heat treatment conditions for Ex. 1 (Exs. 1-1 to 1-7)

| | |
|---|---|
| Time | Temperature |
| (minutes) | (° C.) |

Ex. 1-1

| | |
|---|---|
| 0 | 25 |
| 45 | 475 |
| 105 | 475 |
| 180 | 400 |
| 240 | 25 |

Ex. 1-2

| | |
|---|---|
| 0 | 25 |
| 48.5 | 510 |
| 168.5 | 510 |
| 253.5 | 425 |
| 313.5 | 25 |

Ex. 1-3

| | |
|---|---|
| 0 | 25 |
| 50 | 525 |
| 110 | 525 |
| 185 | 450 |
| 245 | 25 |

Ex. 1-4

| | |
|---|---|
| 0 | 25 |
| 52.5 | 550 |
| 67.5 | 550 |
| 142.5 | 475 |
| 202.5 | 25 |

Ex. 1-5

| | |
|---|---|
| 0 | 25 |
| 50 | 525 |
| 170 | 525 |
| 245 | 450 |
| 60 | 25 |

Ex. 1-6

| | |
|---|---|
| 0 | 25 |
| 52.5 | 550 |
| 112.5 | 550 |
| 187.5 | 475 |
| 247.5 | 25 |

Ex. 1-7

| | |
|---|---|
| 0 | 25 |
| 5 | 525 |
| 200 | 525 |
| 205 | 25 |

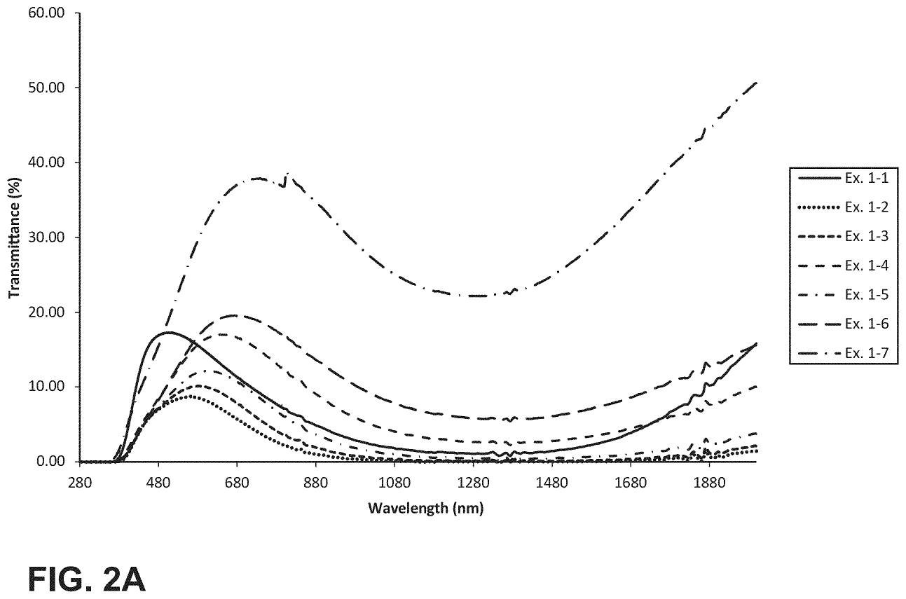

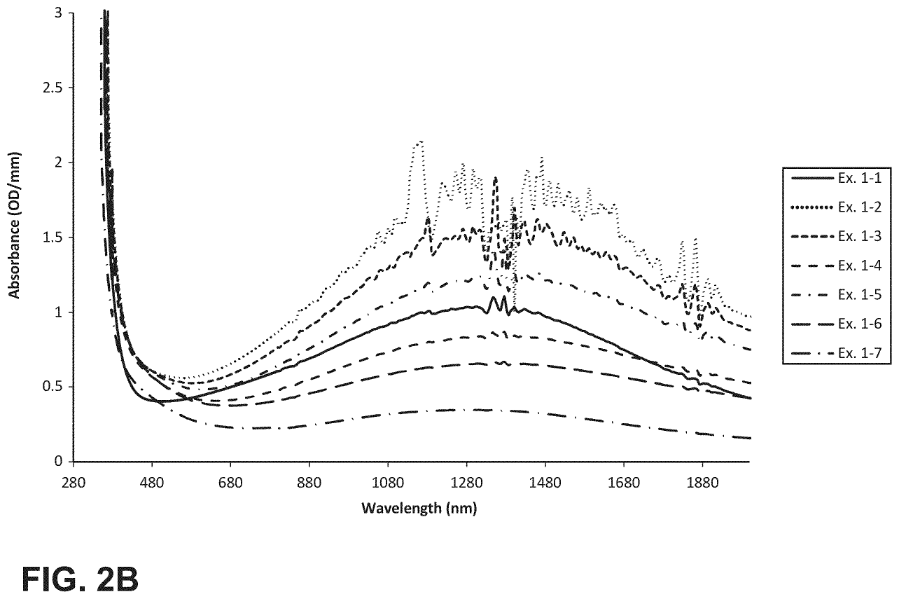

Referring now to FIGS. 2A and 2B, plots of transmittance (%) and absorbance (OD/mm), respectively, are provided for the heat-treated samples (see Table 5) of the Ex. 1 composition. In particular, samples having a 1.9 mm thickness (as-polished) were measured for transmittance and absorbance over a wavelength range from 280 nm to 2000 nm. As is evident from FIGS. 2A and 2B, six of the seven heat-treated samples (Exs. 1-1 to 1-6) exhibit low UV and NIR transmittance. Further, the absorbance data from FIG. 2B has been tabulated below in Tables 6a, 6b, and 6c to provide average, minimum and maximum absorbance values, respectively.

TABLE 6a
Average absorbance for Exs. 1-1 to 1-7 (OD/mm)

| Average Absorbance | | | | | | | | |
|---|---|---|---|---|---|---|---|---|
| (OD/mm) | | Ex. 1-1 | Ex. 1-2 | Ex. 1-3 | Ex. 1-4 | Ex. 1-5 | Ex. 1-6 | Ex. 1-7 |
| <365 | nm | >2 | >2 | >2 | >2 | >2 | >2 | >2 |
| 365-400 | nm | 1.1528 | 1.9004 | 1.8240 | 1.3643 | 1.7174 | 1.4240 | 0.9302 |
| 400-700 | nm | 0.4551 | 0.6331 | 0.6011 | 0.5112 | 0.5706 | 0.5047 | 0.3531 |
| 700-1500 | nm | 0.7606 | 1.2082 | 1.0431 | 0.6118 | 0.8586 | 0.5007 | 0.2726 |
| 700-2000 | nm | 0.7334 | 1.2586 | 1.0861 | 0.6278 | 0.8929 | 0.5087 | 0.2591 |

TABLE 6b
Minimum absorbance for Exs. 1-1 to 1-7 (OD/mm)

| Minimum Absorbance | | | | | | | |
|---|---|---|---|---|---|---|---|
| (OD/mm) | Ex. 1-1 | Ex. 1-2 | Ex. 1-3 | Ex. 1-4 | Ex. 1-5 | Ex. 1-6 | Ex. 1-7 |
| 365-400 nm | 0.7380 | 1.0779 | 1.0437 | 0.9521 | 1.0236 | 1.0029 | 0.6955 |
| 400-700 nm | 0.4014 | 0.5569 | 0.5233 | 0.4046 | 0.4818 | 0.3724 | 0.2239 |
| 700-1500 nm | 0.5137 | 0.6833 | 0.6050 | 0.4170 | 0.5261 | 0.3748 | 0.2160 |
| 700-2000 nm | 0.4214 | 0.6833 | 0.6050 | 0.4170 | 0.5261 | 0.3748 | 0.1555 |

TABLE 6c
Maximum absorbance for Exs. 1-1 to 1-7 (OD/mm)

| Maximum Absorbance | | | | | | | |
|---|---|---|---|---|---|---|---|
| (OD/mm) | Ex. 1-1 | Ex. 1-2 | Ex. 1-3 | Ex. 1-4 | Ex. 1-5 | Ex. 1-6 | Ex. 1-7 |
| 365-400 nm | 1.8394 | 10.0000 | 10.0000 | 2.1295 | 10.0000 | 2.3423 | 1.2974 |
| 400-700 nm | 0.7380 | 1.0779 | 1.0437 | 0.9521 | 1.0236 | 1.0029 | 0.6955 |
| 700-1500 nm | 1.0994 | 2.1486 | 1.9000 | 0.8665 | 1.4892 | 0.6666 | 0.3445 |
| 700-2000 nm | 1.0994 | 2.1486 | 1.9000 | 0.8665 | 1.4892 | 0.6666 | 0.3445 |

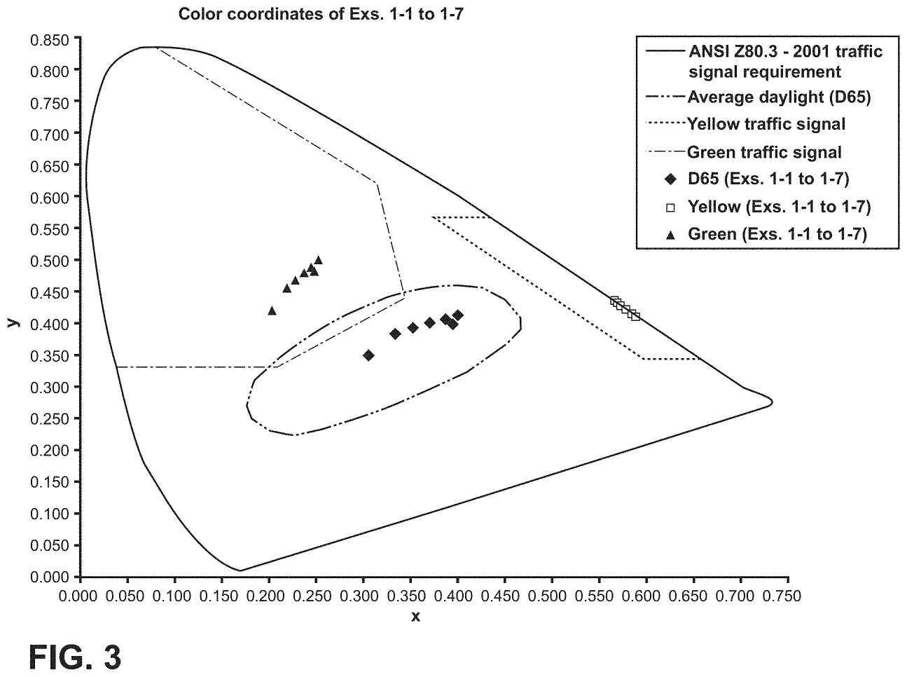

Further, each of the samples (Exs. 1-1 to 1-7) of the Ex. 1 composition exhibited a different neutral color (e.g., olive, grey, mauve, tan, dark green, etc.), which satisfied the sunglass specification of ANSI Z80.3-2001. Referring to FIG. 3, a plot of X and Y color coordinates is provided for the heat-treated examples of Ex. 1 (i.e., Exs. 1-1 to 1-7) in view of the ANSI Z80.3-2001 traffic signal requirement, which must be satisfied by a material to be defined as a ‘sunglass’ material. As is evident from FIG. 3, each of the samples satisfies the yellow, green and daylight (D65 2°) portions of the ANSI Z80.3-2001 requirement. Further, transmittance measurements in certain wavelength regions (UVB, UVA, visible and NIR) and color coordinates were obtained on each of the samples Exs. 1-1 to 1-7 of the Example 1 composition and evaluated against various sunglass optical requirements. In sum, each of the samples (Exs. 1-1 to 1-7) satisfied the sunglass requirements of ISO 12312-1:2013 (IR protection), ANSI Z80.3-2001 (traffic signal), and AS 1067-2003 (UV absorption). In addition, the x and y color coordinate data for the D65 2° illumination condition is provided below for each of these samples in Table 7a, with minimum and maximum values provided in Table 7b.

TABLE 7a
Color coordinates for Exs. 1-1 to 1-7

| Color Coordinates | | | | | | | |
|---|---|---|---|---|---|---|---|
| Daylight | | | | | | | |
| (D65 2° Illumination) | Ex. 1-1 | Ex. 1-2 | Ex. 1-3 | Ex. 1-4 | Ex. 1-5 | Ex. 1-6 | Ex. 1-7 |
| x | 0.3051 | 0.3339 | 0.3527 | 0.3873 | 0.3706 | 0.4003 | 0.3938 |
| y | 0.3484 | 0.3824 | 0.3916 | 0.4049 | 0.4000 | 0.4117 | 0.3989 |

TABLE 7b
Minimum and maximum color coordinates for Exs. 1-1 to 1-7

| Color Coordinates Daylight | | |
|---|---|---|
| (D65 2° Illumination) | Minimum | Maximum |
| x | 0.3051 | 0.4003 |
| y | 0.3484 | 0.4117 |

### Example 2

In this example, the effect of excess alkali content in the glass compositions of the disclosure was investigated. Without being bound by theory, and as noted earlier, the excess alkali content in the compositions of the disclosure influences the polychromatic effects observed in these compositions upon various heat treatment conditions. The increased alkali content of these compositions allows for greater changes and variations in the MₓWO₃ crystal stoichiometry, resulting in a shift in band gap energy that is manifested in color changes. More particularly, when the dopant “M” is an alkali cation (Li, Na, K, Rb and/or Cs) and as the concentration “x” is increased, the absorbance and color of the resulting glass or glass-ceramic compositions changes. Conversely, when there is limited alkali available to interact with the tungsten and/or molybdenum oxide to form alkali tungsten and/or molybdenum bronze crystals in the form of MₓWO₃, the range of “x” is limited or bounded.

Again without being bound by theory, in the tungsten-containing (and mixed tungsten/molybdenum-containing) alkali-alumino-borosilicates in this disclosure, there are multiple species that compete for alkali cations. These include alumina, silica, boron, and tungsten. Out of those species, alumina competes for alkalis most strongly, and in-turn it was found that by optimizing the alkali to alumina ratio (i.e., R₂O—Al₂O₃) that the concentration of alkali cations available to interact with the tungsten oxide to form alkali tungsten bronze crystals can be controlled. This enables the stoichiometric range of the alkali tungsten bronze crystals developed in the glass ceramic to be controlled. Accordingly, in compositions where there is only a small excess of alkali relative to alumina (i.e., R₂O—Al₂O₃≤0.25 mol %), only blue-colored tungsten bronze crystals (presumably of the form MₓWO₃, where 0<x<0.4) are formed. If there is more alkali present, by optimizing thermal treatment, tungsten bronze crystals with higher “M” cation concentration can be produced, thereby accessing a wider range of colors.

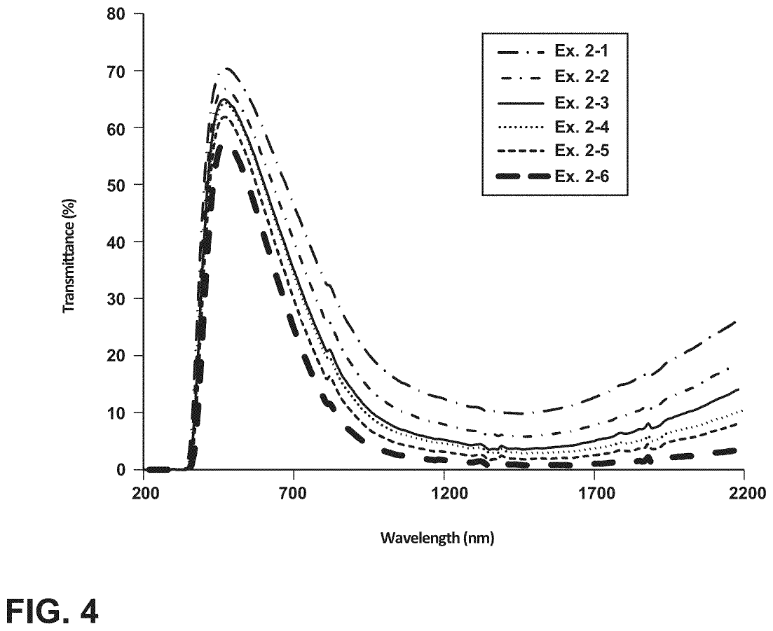

An example of how limiting available alkali can dictate the resultant color range is shown in FIG. 4, which presents the optical transmittance spectra of 0.7 mm thick samples of tungsten bronze glass ceramics having the composition provided below in Table 8a (Ex. 2), which was processed according to the same melting conditions specified in Example 1. Notably, this composition has an R₂O—Al₂O₃ value of +0.24 mol % and was heat treated according to this example for different times and temperatures (see Table 8b for the heat treatments associated with the samples designated Exs. 2-1 to 2-6). As shown in FIG. 4, increasing heat treatment temperature and time decreases the total transmittance of the samples, but the shape of all spectra and their colors are similar, suggesting that the stoichiometry of the crystals formed are comparable to one another. In contrast, other samples with higher R₂O—Al₂O₃ levels demonstrate more significant polychromatic effects. For example, see Table 4, Ex. 1-C, R₂O—Al₂O₃=0.973 mol %, which produces blue, green, orange and brown upon being subjected to various heat treatment conditions consistent with those of Tables 5 and 8b. Accordingly, while these samples demonstrate some polychromatic effects with varying heat treatment conditions, the results suggest that the R₂O—Al₂O₃ value of +0.24 mol % is in proximity to the lower bound of the R₂O—Al₂O₃ for the compositions of the disclosure. Nevertheless, a boundary or limit associated with the R₂O—Al₂O₃ can change for the compositions of disclosure as there are multiple factors that impact alkali availability. Total silica and boron concentration can also impact availability of alkali for purposes of generating polychromatic effects in these compositions upon heat treatment. Further, the addition of molybdenum oxide to form mixed tungsten/molybdenum bronze crystals can also result in the need for less of an excess alkali condition (e.g., R₂O—Al₂O₃ as low as 0.1 mol %) to achieve polychromatic effects. Additionally, if the R₂O—Al₂O₃ level becomes too large (e.g., >4 mol %), the amount of alkalis can also prevent the generation of a broad range of crystal stoichiometries (and in-turn different colors) because the large excess of alkali cations promotes the formation of higher stoichiometry tungsten bronzes (e.g., where x>0.7 mol %) or stoichiometric alkali tungstates (e.g., M₂WO₄, where M=an alkali).

TABLE 8a
Polychromatic Ag-free W bronze ceramic composition
(R₂O—Al₂O₃ ~0.24 mol %)

| Constituent | Ex. 2 (mol %) |
|---|---|
| SiO₂ | 67.17 |
| Al₂O₃ | 9.62 |
| B₂O₃ | 9.42 |
| Li₂O | 7.69 |
| Na₂O | 0.58 |
| K₂O | 1.59 |
| SnO₂ | 0.10 |
| WO₃ | 3.85 |
| R₂O—Al₂O₃ | 0.24 |

TABLE 8b
Heat treatment conditions for Ex. 2 (Exs. 2-1 to 2-6)

| | |
|---|---|
| Time | Temperature |
| (minutes) | (° C.) |

Ex. 2-1

| | |
|---|---|
| 0 | 25 |
| 50 | 525 |
| 140 | 525 |
| 215 | 450 |
| 275 | 25 |

Ex. 2-2

| | |
|---|---|
| 0 | 25 |
| 50 | 525 |
| 200 | 525 |
| 275 | 450 |
| 336 | 25 |

Ex. 2-3

| | |
|---|---|
| 0 | 25 |
| 52.5 | 550 |
| 112.5 | 550 |
| 187.5 | 475 |
| 247.5 | 25 |

Ex. 2-4

| | |
|---|---|
| 0 | 25 |
| 52.5 | 550 |
| 142.5 | 550 |
| 217.5 | 475 |
| 277.5 | 25 |

Ex. 2-5

| | |
|---|---|
| 0 | 25 |
| 55 | 575 |
| 100 | 575 |
| 175 | 500 |
| 235 | 25 |

Ex. 2-6

| | |
|---|---|
| 0 | 25 |
| 55 | 575 |
| 115 | 575 |
| 190 | 500 |
| 250 | 25 |

### Example 3

In this example, the effect of tin oxide in the glass compositions of the disclosure was investigated. As noted earlier, the change in crystal stoichiometry of the glass compositions of the disclosure can be manifested by a change in the tungsten (or molybdenum) oxidation state, which in-turn requires a different “M” cation concentration in the crystal to maintain charge neutrality. In these glass ceramic systems, SnO₂ introduced into the batch acts as the reducing agent of the tungsten oxide, enabling its partial reduction from the 6+ oxidation state, which results in a change in color. The higher the initial SnO₂ concentration, the more reduced tungsten is generated upon thermal treatment. It should be clarified that it is not tin IV (Sn⁴⁺) that acts as the reducing agent of tungsten oxide; rather, it is the fraction of tin II (i.e., Sn²⁺) that is generated in the glass during high temperature processing and melting that later acts as a reducing agent. Accordingly, the melting temperature of the glass compositions of the disclosure can also influence the concentration of tin II produced, which later can impact the degree of color changing effects observed in the glass upon subsequent heat treatment.

As provided below in Table 9, four glass compositions with varying levels of SnO₂ were prepared (i.e., Comp. Ex. 3 and Exs. 3A, 3B and 3C) according to the processing and melting condition specified in Example 1. Each of these samples, Comp. Ex. 3 and Exs. 3A-3C, was prepared with varying levels of SnO₂, 0 mol %, 0.1 mol %, 0.2 mol % and 0.4 mol %, respectively. All of the samples were heat treated at 650° C. and then cooled in ambient air. Upon heat treatment, the samples exhibited the following hues: no hue (Comp. Ex. 3); blue (Ex. 3A); green (Ex. 3B); and orange (Ex. 3C). As the Comp. Ex. 3 contains 0 mol % SnO₂, it was deemed comparative for purposes of this example.

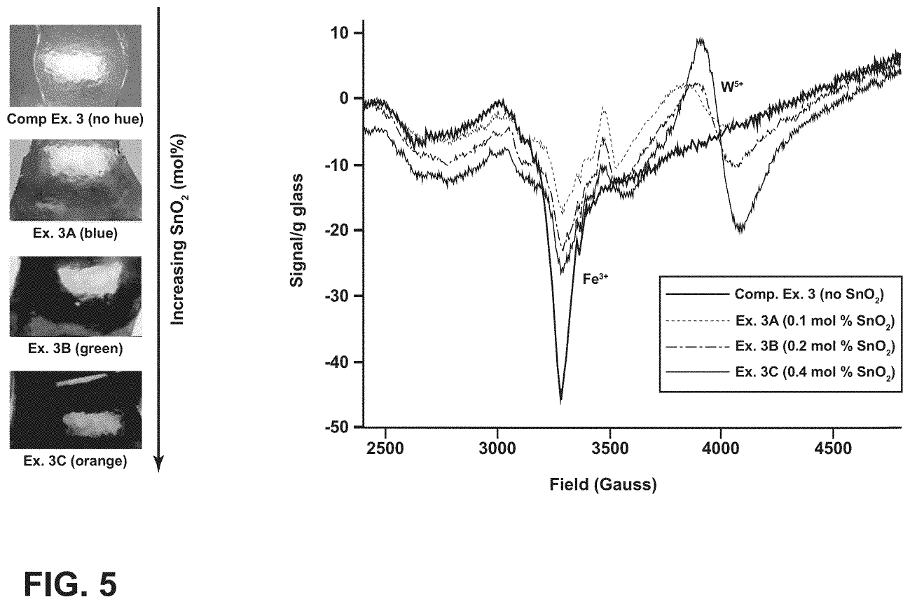

Referring now to FIG. 5, a plot of electro-paramagnetic resonance (EPR) measurements as a function of magnetic field is provided for the heat-treated samples of Exs. 3A-3C compositions and samples of the heat-treated comparative composition, Comp. Ex. 3 (i.e., without SnO₂), along with images of these examples. EPR was conducted with an X-Band continuous wave EPR (9.4 GHz) system on small ‘chips’, 0.1 g total, contained in standard 5 mm NMR/EPR glass tubes. The measurements were conducted near liquid nitrogen temperature, using high power (100 mW) and high modulation amplitude. Further, the EPR signal was normalized to sample mass (e.g., signal/g was reported for each sample in FIG. 5), allowing for more direct comparison of signal intensities. As is evident from FIG. 5, the SnO₂-free compositions (Comp. Ex. 3) exhibit no strong signal at 3800-4000 Gauss (a field level which is understood in the literature to indicate the W⁵⁺ state), thus confirming that all of the tungsten in this sample is in its highest oxidation state (W⁶⁺ state). With increasing levels of SnO₂ (Exs. 3A-3C), the samples demonstrated an increasingly stronger W⁵⁺ signal, thus indicating that more of the tungsten has been reduced by the tin content. As such, it is evident from the data in FIG. 5 that SnO₂ serves as a redox couple for W in the glass-ceramic compositions of the disclosure, and as more is added, there is a greater fraction of the W converted from a W⁶⁺ state to more reduced forms (e.g., W⁵⁺ states).

In light of these observations from FIG. 5, the compositions of the disclosure should have sufficient tin oxide introduced to enable the partial reduction of the tungsten VI in the glass to form alkali tungsten bronze crystals. Otherwise, the tungsten will remain in the W⁶⁺ oxidation state. Conversely, if there is too much SnO₂, the tungsten VI is rapidly reduced and it becomes difficult to control the precise crystal stoichiometry through controlling heat treatment conditions. Accordingly, careful optimization of tin enables a wide range of stoichiometries to be controllably achieved through thermal treatment in the glass compositions of the disclosure, thus enabling polychromatic effects.

TABLE 9
Polychromatic Ag-free W bronze ceramic
composition with varying SnO₂ levels

| Constituent | Comp. Ex. 3 | Ex. 3A | Ex. 3B | Ex. 3C |
|---|---|---|---|---|
| SiO₂ | 66 | 65.9 | 65.8 | 65.6 |
| B₂O₃ | 20 | 20 | 20 | 20 |
| Al₂O₃ | 9 | 9 | 9 | 9 |
| Li₂O | 3 | 3 | 3 | 3 |
| WO₃ | 2 | 2 | 2 | 2 |
| SnO₂ | 0 | 0.1 | 0.2 | 0.4 |

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and, further, it is to be understood that such concepts are intended to be covered by the following claims, unless these claims, by their language, expressly state otherwise. Further, the claims, as set forth below, are incorporated into and constitute part of this Detailed Description.

What is claimed is:

1. An article, comprising:
SiO₂ from 40 mol % to 80 mol %;
Al₂O₃ from 1 mol % to 15 mol %;
B₂O₃ from 5 mol % to 50 mol %;
WO₃ from 1 mol % to 15 mol %;
WO₃ plus MoO₃ from 1 mol % to 18 mol %;
SnO₂ from 0.01 mol % to 1 mol %; and
R₂O from 1.1 mol % to 16 mol %, wherein the R₂O is one or more of Li₂O, Na₂O, K₂O, Rb₂O and Cs₂O,
wherein R₂O—Al₂O₃ ranges from +0.1 mol % to +4 mol %.

2. The article of claim 1, further comprising:
P₂O₅ from 0 mol % to 3 mol %; and
F from 0 mol % to 15 mol %.

3. The article of claim 1, further comprising:
RO from 0 mol % to 2 mol %, wherein RO is one or more of MgO, CaO, SrO and BaO.

4. The article of claim 1, wherein the article is substantially free of Au, Ag, V and Cu.

5. The article of claim 1, wherein the article comprises a transmittance of at least 7% within a wavelength band from 390 nm to 700 nm at a thickness of 1.9 mm.

6. The article of claim 1, wherein the article exhibits an average absorbance from 0.2 OD/mm to 1.5 OD/mm in a wavelength band from 700 nm to 2000 nm.

7. The article of claim 1, wherein the article exhibits a minimum absorbance from 0.1 OD/mm to 1.2 OD/mm in a wavelength band from 365 nm to 2000 nm.

8. The article of claim 1, wherein the article exhibits a set of transmitted color coordinates having: a minimum X value from 0.25 to 0.45 and a minimum Y value from 0.3 to 0.5, as measured under a CIE Standard illuminant D65 at 2°.

9. The article of claim 1, further comprising:
a plurality of precipitates comprising an oxide of one or more of the chemical forms MₓWO₃ and MₓMoO₃, wherein M is one or more of Li, Na, K, Rb and Cs and 0<x<1.

10. The article of claim 9, wherein the plurality of precipitates comprises W⁵⁺.

11. An article, comprising:
SiO₂ from 45 mol % to 75 mol %;
Al₂O₃ from 7 mol % to 15 mol %;
B₂O₃ from 5 mol % to 25 mol %;
WO₃ from 1 mol % to 7 mol %;
WO₃ plus MoO₃ from 2 mol % to 10 mol %;
SnO₂ from 0.05 mol % to 0.4 mol %; and
R₂O from 8 mol % to 16 mol %, wherein the R₂O is one or more of Li₂O, Na₂O, K₂O, Rb₂O and Cs₂O,
wherein R₂O—Al₂O₃ ranges from +1 mol % to +3 mol %.

12. The article of claim 11, further comprising:
P₂O₅ from 0 mol % to 2 mol %; and
F from 1 mol % to 10 mol %.

13. The article of claim 11, further comprising:
RO from 0.01 mol % to 1 mol %, wherein RO is one or more of MgO, CaO, SrO and BaO.

14. The article of claim 11, wherein the article is substantially free of Au, Ag, V and Cu.

15. The article of claim 11, wherein the article comprises a transmittance of at least 7% within a wavelength band from 390 nm to 700 nm at a thickness of 1.9 mm.

16. The article of claim 11, wherein the article exhibits an average absorbance from 0.25 OD/mm to 1.30 OD/mm in a wavelength band from 700 nm to 2000 nm.

17. The article of claim 11, wherein the article exhibits a minimum absorbance from 0.15 OD/mm to 1.1 OD/mm in a wavelength band from 365 nm to 2000 nm.

18. The article of claim 11, wherein the article exhibits a set of transmitted color coordinates having: a minimum X value from 0.3 to 0.4 and a minimum Y value from 0.35 to 0.41, as measured under a CIE Standard illuminant D65 at 2°.

19. An article, comprising:
SiO₂ from 50 mol % to 56 mol %;
Al₂O₃ from 10 mol % to 12 mol %;
B₂O₃ from 10 mol % to 15 mol %;
WO₃ from 2 mol % to 4 mol %;
WO₃ plus MoO₃ from 3 mol % to 6 mol %;
SnO₂ from 0.1 mol % to 0.3 mol %; and
R₂O from 11.1 mol % to 16.1 mol %, wherein the R₂O is one or more of Li₂O, Na₂O, K₂O, Rb₂O and Cs₂O,
wherein R₂O—Al₂O₃ ranges from +1.1 mol % to +2 mol %.

20. The article of claim 19, further comprising at least one of:
(a) P₂O₅ from 0 mol % to 1.5 mol % and F from 3 mol % to 7 mol %; and
(b) RO from 0.05 mol % to 0.5 mol %, wherein RO is one or more of MgO, CaO, SrO and BaO.
